(19) United States
(12) Patent Application Publication
(10) Pub. No.: US 2024/0420574 A1
(43) Pub. Date: Dec. 19, 2024

(54) COMMUNICATION FOR VEHICLE SAFETY SYSTEM

(71) Applicant: QUALCOMM Incorporated, San Diego, CA (US)

(72) Inventors: Anantharaman Balasubramanian, San Diego, CA (US); Dan Vassilovski, Del Mar, CA (US); Mohit Narula, San Diego, CA (US); Mayank Manocha, San Diego, CA (US); Richard Reid Hovey, Branchburg, NJ (US); Arzu Karaer, San Diego, CA (US); Shailesh Patil, San Diego, CA (US)

(21) Appl. No.: 18/335,307

(22) Filed: Jun. 15, 2023

(51) Int. Cl. G08G 1/16; G08G 1/00; G08G 1/01

(52) U.S. Cl. CPC G08G 1/164; G08G 1/0112; G08G 1/0133; G08G 1/22

(57) ABSTRACT

This disclosure provides systems, methods, and devices for wireless communication that support a safety system. In a first aspect, a method of wireless communication includes receiving, from a first mobile entity, first information of the first mobile entity. The method also includes transmitting, to the first mobile entity, a group configuration information. The group configuration information is generated based on the map information and indicates a group that includes the first mobile entity and a second mobile entity. The method further includes transmitting alert information to the group. Other aspects and features are also claimed and described.

### TECHNICAL FIELD

Aspects of the present disclosure relate generally to wireless communication systems, and more particularly, to a safety system, such as a safety system that associated with a vehicle and that utilizes map data. Some features may enable and provide improved entity tracking, improved and more relevant safety alerts, reduced communication overhead, improved power efficiency, a reduction in intersection accidents, scalability, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Vehicle-to-everything (V2X) technology enables sharing of information from a vehicle to another device or entity that may affect the vehicle, and vice versa. V2X technology is associated with a vehicular communication system that can include one or more aspects or types of communication, such as vehicle-to-vehicle (V2V), vehicle-to-infrastructure (V2I), vehicle-to-network (V2N), vehicle-to-pedestrian (V2P), vehicle-to-device (V2D), and vehicle-to-grid (V2G), as illustrative, non-limiting examples. V2X technology can utilize cellular based communication or wireless local area network communication. In some implementations, messages and communication for the V2X technology are at an application and use an underlying radio as pipe (a communication path).

V2X-capable vehicles periodically broadcast their current status using application-layer messages such as the Basic Safety Message (BSM) or Cooperative Awareness Messages (CAM), nominally transmitted at a 100 milliseconds (ms) periodicity. These transmissions constitute the V2X basic safety capability, and at a minimum include vehicle identity, location, and motion state. In addition to basic safety, standards bodies, such as Society of Automotive Engineers (SAE), European Telecommunications Standards Institute (ETSI)-European Telecommunication Standard (ETS), and Chinese Standards Association, Society of Automotive Engineers of China (CSAE), are developing application-layer standards for advanced features including sensor-sharing (such as dissemination of detected vehicles or objects) and coordinated driving (such as sharing and negotiating intended maneuvers). In a V2P system, such messages may be detected may on or more UEs and used to alert a vulnerable road user (VRU), such as pedestrians, cyclists, and other micro-mobility user (e.g., scooter, Segway, etc.), to the presence of one or more vehicles. As compared to a roadway vehicle, such as a car, truck, or other vehicle that includes an alternator, a UE typically includes a storage device, such as a battery, which can be sensitive to power consumption. Frequent or continuous monitoring of V2X application-layer messages can present an unacceptable power drain (battery drain) for the UE.

Additionally, even with the implementation of such messages, a VRU may still be at risk of injury or a potential collision with a vehicle in certain circumstances, such as at an intersection, due to driver distraction or impairment, VRU distraction (e.g., the VRU at an intersection may be looking at a smart phone or watch/wearable while walking, jogging, or cycling), or a combination thereof. A VRU safety system may be configured to receives BSMs from each of multiple vehicles that approach the intersection and to determine a potential collusion with a VRU based on the BSMs. However, receiving BSMs from the multiple vehicles increases communication overhead and provides the VRU safety system with multiple BSMs to process. In such circumstance, the VRU safety system may experience increased latency associated with receiving and processing the BSMs.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication is performed by a server. The method includes receiving, from a first mobile entity, first information of the first mobile entity. The method further includes transmitting, to the first mobile entity, a group configuration information. The group configuration information is generated based on map information and indicates a group that includes the first mobile entity and a second mobile entity. The method also includes transmitting alert information to the group.

In an additional aspect of the disclosure, an apparatus includes at least one processor and a memory coupled to the at least one processor. The at least one processor is configured to receive, from a first mobile entity, first information of the first mobile entity. The at least one processor is further configured to transmit, to the first mobile entity, a group configuration information, the group configuration information. The group configuration information is generated based on map information and indicates a group that includes the first mobile entity and a second mobile entity. The at least one processor is also configured to transmit alert information to the group.

In an additional aspect of the disclosure, an apparatus includes means for receiving, from a first mobile entity, first information of the first mobile entity. The apparatus further includes means for transmitting, to the first mobile entity, a group configuration information, the group configuration information. The group configuration information is generated based on map information and indicates a group that includes the first mobile entity and a second mobile entity. The apparatus also includes means for transmitting alert information to the group.

In an additional aspect of the disclosure, a non-transitory computer-readable medium stores instructions that, when executed by a processor, cause the processor to perform operations. The operations include receiving, from a first mobile entity, first information of the first mobile entity. The operations further include transmitting, to the first mobile entity, a group configuration information. The group configuration information is generated based on map information and indicates a group that includes the first mobile entity and a second mobile entity. The operations also include transmitting alert information to the group.

In an additional aspect of the disclosure, an apparatus includes a communication interface configured to receive, from a first mobile entity, first information of the first mobile entity. The communication interface is further configured to transmit, to the first mobile entity, a group configuration information. The group configuration information is generated based on map information and indicates a group that includes the first mobile entity and a second mobile entity. The apparatus further includes at least one processor coupled to a memory storing processor-readable code. The at least one processor is configured to execute the processor-readable code to cause the at least one processor to generate alert information for the group.

In one aspect of the disclosure, a method for wireless communication is performed by a server. The method includes receiving, from a first mobile entity, an indicator that indicates position accuracy information associated with a position estimate of the first mobile entity based on a signal received from a non-terrestrial entity. The method further includes transmitting alert information to one or more mobile entities. The alert information is associated with a potential collision between an object and the one or more mobile entities, and the potential collision is determined based on the indicator.

In an additional aspect of the disclosure, an apparatus includes at least one processor and a memory coupled to the at least one processor. The at least one processor is configured to receive, from a first mobile entity, an indicator that indicates position accuracy information associated with a position estimate of the first mobile entity based on a signal received from a non-terrestrial entity. The at least one processor is further configured to transmit alert information to one or more mobile entities. The alert information is associated with a potential collision between an object and the one or more mobile entities, and the potential collision is determined based on the indicator.

In an additional aspect of the disclosure, an apparatus includes means for receiving, from a first mobile entity, an indicator that indicates position accuracy information associated with a position estimate of the first mobile entity based on a signal received from a non-terrestrial entity. The apparatus further includes means for transmitting alert information to one or more mobile entities. The alert information is associated with a potential collision between an object and the one or more mobile entities, and the potential collision is determined based on the indicator.

In an additional aspect of the disclosure, a non-transitory computer-readable medium stores instructions that, when executed by a processor, cause the processor to perform operations. The operations include receiving, from a first mobile entity, an indicator that indicates position accuracy information associated with a position estimate of the first mobile entity based on a signal received from a non-terrestrial entity. The operations further include transmitting alert information to one or more mobile entities. The alert information is associated with a potential collision between an object and the one or more mobile entities, and the potential collision is determined based on the indicator.

In an additional aspect of the disclosure, an apparatus includes a communication interface configured to receive, from a first mobile entity, an indicator that indicates position accuracy information associated with a position estimate of the first mobile entity based on a signal received from a non-terrestrial entity. The apparatus further includes at least one processor coupled to a memory storing processor-readable code. The at least one processor is configured to execute the processor-readable code to cause the at least one processor to generate alert information for one or more mobile entities. The alert information is associated with a potential collision between an object and the one or more mobile entities, and the potential collision is determined based on the indicator.

In one aspect of the disclosure, a method for wireless communication performed by a mobile entity includes transmitting, to a server, first information of the mobile entity. The method also includes receiving, from the server, a group configuration information. The group configuration information is based on map information and indicates a group that includes the mobile entity and another mobile entity. The method further includes communicating, based on the group configuration information, with the other mobile entity of the group.

In an additional aspect of the disclosure, a mobile entity includes a memory storing processor-readable code, and at least one processor coupled to the memory. The at least one processor is configured to execute the processor-readable code to cause the at least one processor to transmit, to a server, first information of the mobile entity. The at least one processor is further configured to execute the processor-readable code to cause the at least one processor to receive, from the server, a group configuration information. The group configuration information is based on map information and indicates a group that includes the mobile entity and another mobile entity. The at least one processor is also configured to execute the processor-readable code to cause the at least one processor to communicate, based on the group configuration information, with the other mobile entity of the group.

In an additional aspect of the disclosure, an apparatus includes means for transmitting, to a server, first information of the mobile entity. The apparatus further includes means for receiving, from the server, a group configuration information. The group configuration information is based on map information and indicates a group that includes the mobile entity and another mobile entity. The apparatus also includes means for communicating, based on the group configuration information, with the other mobile entity of the group.

In an additional aspect of the disclosure, a non-transitory computer-readable medium stores instructions that, when executed by a processor, cause the processor to perform operations. The operations include transmitting, to a server, first information of the mobile entity. The operations further include receiving, from the server, a group configuration information. The group configuration information is based on map information and indicates a group that includes the mobile entity and another mobile entity. The operations also include communicating, based on the group configuration information, with the other mobile entity of the group.

In an additional aspect of the disclosure, an apparatus includes at least one processor coupled to a memory storing processor-readable code. The at least one processor is configured to execute the processor-readable code to cause the at least one processor to generate first information of the mobile entity. The apparatus further includes a communication interface configured to transmit, to a server, the first information of the mobile entity, and receive, from the server, a group configuration information. The group configuration information is based on map information and indicates a group that includes the mobile entity and another mobile entity. The communication interface is further configured to communicate, based on the group configuration information, with the other mobile entity of the group.

In one aspect of the disclosure, a method for wireless communication performed by a mobile entity includes receiving a signal from a non-terrestrial entity. The method also includes transmitting an indicator that indicates position accuracy information associated with a position estimate of the mobile entity. The position estimate of the mobile entity is based on the received signal.

In an additional aspect of the disclosure, a mobile entity includes a memory storing processor-readable code, and at least one processor coupled to the memory. The at least one processor is configured to execute the processor-readable code to cause the at least one processor to receive a signal from a non-terrestrial entity. The at least one processor is further configured to execute the processor-readable code to cause the at least one processor to transmit an indicator that indicates position accuracy information associated with a position estimate of the mobile entity. The position estimate of the mobile entity is based on the received signal.

In an additional aspect of the disclosure, an apparatus includes means for receiving a signal from a non-terrestrial entity. The apparatus further includes means for transmitting an indicator that indicates position accuracy information associated with a position estimate of the mobile entity. The position estimate of the mobile entity is based on the received signal.

In an additional aspect of the disclosure, a non-transitory computer-readable medium stores instructions that, when executed by a processor, cause the processor to perform operations. The operations include receiving a signal from a non-terrestrial entity. The operations further include transmitting an indicator that indicates position accuracy information associated with a position estimate of the mobile entity. The position estimate of the mobile entity is based on the received signal.

In an additional aspect of the disclosure, an apparatus includes a communication interface configured to receive a signal from a non-terrestrial entity. The apparatus further includes at least one processor coupled to a memory storing processor-readable code. The at least one processor is configured to execute the processor-readable code to cause the at least one processor to generate an indicator that indicates position accuracy information associated with a position estimate of the mobile entity. The position estimate of the mobile entity is based on the received signal.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports a safety system according to one or more aspects.

FIG. 5 is a diagram illustrating examples of dilution of precision scenarios according to one or more aspects.

FIG. 6 is a ladder diagram illustrating an example of operations of a safety system according to one or more aspects.

FIG. 7 is a flow diagram illustrating an example process that supports a safety system according to one or more aspects.

FIG. 8 is a flow diagram illustrating an example process that supports a safety system according to one or more aspects.

FIG. 9 is a flow diagram illustrating an example process that supports a safety system according to one or more aspects.

FIG. 10 is a flow diagram illustrating an example process that supports a safety system according to one or more aspects.

FIG. 11 is a perspective view of a motor vehicle with a driver monitoring system according to one or more aspects.

FIG. 12 is a block diagram of an example server that supports a safety system according to one or more aspects.

FIG. 13 is a block diagram of an example network entity that supports a safety system according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support a safety system. For example, the present disclosure describes a server, such as a car-2-cloud server, that is configured to receive a safety message for a group of mobile entities and to detect, based on the safety message, a potential collision associated with at least one mobile entity of the group. To illustrate, the server may select a configuration for the group of one or more mobile entities, such as one or more vehicles. The selection of the configuration may be based on map information, such as a population density (e.g., rural, semi-rural, urban, suburban, or city center), a traffic density (e.g., recurring congestion, non-recurring congestion, light, medium, heavy, gridlock, emergency, severe, serious, moderate, or minimal), or a combination thereof. For example, in a rural or semi-urban area, the configuration may indicate that one vehicle is designated as a leader of the group and is configured to perform safety message transmission on behalf of the group. As another example, in an urban area, the configuration may indicate that pattern or scheme (e.g., an order) in which different mobile entities of the group are to transmit a safety message for the group. Based on one or more safety messages received from the group, the server may determine an entry time of the group into a zone (e.g., a geo-fenced zone), such as an intersection, an exit time of the group from the zone, or a combination thereof. Based on a determination that the group is within the zone, the server may generate an alert that indicates a potential collision between at least one mobile entity of the group and an object, such as a pedestrian. The server may transmit an alert message to the group based on the potential collision. For example, the server may transmit the alert message to one mobile entity of the group, multiple mobile entities of the group, or to each mobile entity included in the group. In some implementations, the server may be configured to divide a group into multiple sub-groups based on the map information, such as when the group is in a semi-rural area. Alternatively, the server may be configured to combine multiple groups into a combined group based on the map information, such as when the multiple groups are in a rural area. In some implementations, a mobile entity may receive a signal from a satellite vehicle and may determine, based on the received signal, position accuracy information associated with a position estimate of the mobile entity. The mobile entity may transmit an indicator of the position accuracy information, such as a dilution of position (DOP) scalar, to the server.

Particular implementations of the subject matter described in this disclosure may be implemented to realize one or more of the following potential advantages or benefits. In some aspects, the present disclosure provides techniques for supporting a safety system. For example, the techniques described provide configuring a group of one or more vehicles to transmit safety information (e.g., group information) for the group, such as a safety message that is representative of or applicable to the group. By configuring the group to transmit the one or more safety messages representative of or applicable to the group, overhead may be reduced. Additionally, or alternatively, the one or more safety messages representative of or applicable to the group may reduce redundant messaging (e.g., that indicate a speed or a heading) from the vehicles of the group. Additionally, or alternatively, the one or more safety messages representative of or applicable to the group may enable a server to identify a potential collision associated with the group, such as a potential collision for a least one mobile entity of the group, without having received a safety message from the at least one mobile entity of the group. Accordingly, configuring the group and receiving one or more safety messages for the group may minimize over the air transmissions without impacting safety. Additionally, the techniques may provide reduced overhead communications, improved entity tracking, improved and more relevant safety alerts, improved power efficiency, a reduction in intersection accidents, or a combination thereof.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

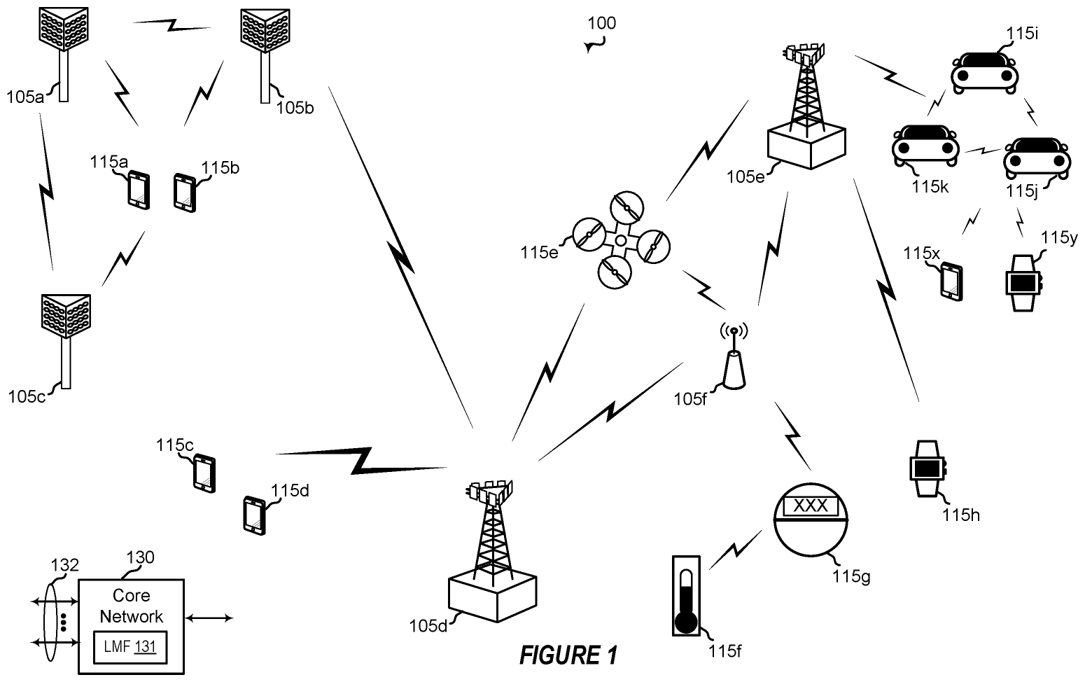

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115c-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c. Additionally, V2V mesh network may include or correspond to a vehicle-to-everything (V2X) network between UEs 115i-115k and one or more other devices, such as UEs 115x, 115y.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a management function, such as a Location Management Function (LMF) 131, a Sensing Management Function (SnMF), or an Access and Mobility Management Function (AMF), which is an entity in the 5G Core Network (5GC) supporting various functionality, such as managing support for different location services for one or more UEs. The SnMF may be configured to manage support for sensing operations for one or more sensing operations or sensing services for one or more devices, such as one or more UEs 115, one or more base stations 105, one or more TRPs, or a combination thereof. For example the SnMF may include one or more servers, such as multiple distributed servers. Base stations 105 may forward sensing messages to the SnMF and may communicate with the SnMF via a NR Positioning Protocol A (NRPPa). The SnMF is configured to control sensing parameters for UEs 115 and the SnMF can provide information to the base stations 105 and UE 115 so that action can be taken at UE 115, base station 105, or another device. The LMF 131 may include one or more servers, such as multiple distributed servers. Base stations 105 may forward location messages to the LMF 131 and may communicate with the LMF 131 via a NR Positioning Protocol A (NRPPa). The LMF 131 is configured to control the positioning parameters for UEs 115 and the LMF 131 can provide information to the base stations 105 and UE 115 so that action can be taken at UE 115. In some implementations, UE 115 and base station 105 are configured to communicate with the LMF 131 via the AMF.

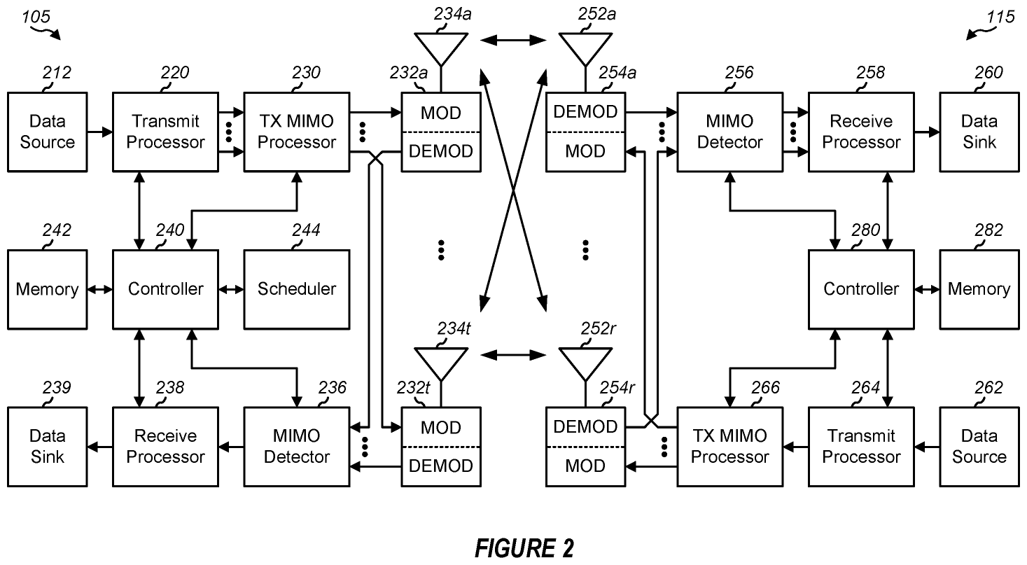

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

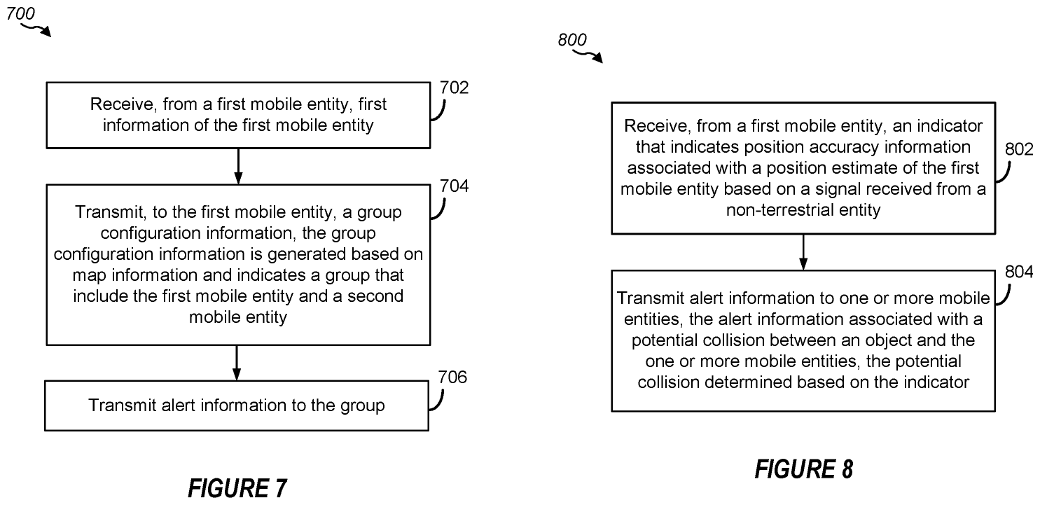

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in or described with reference to FIGS. 7-10, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

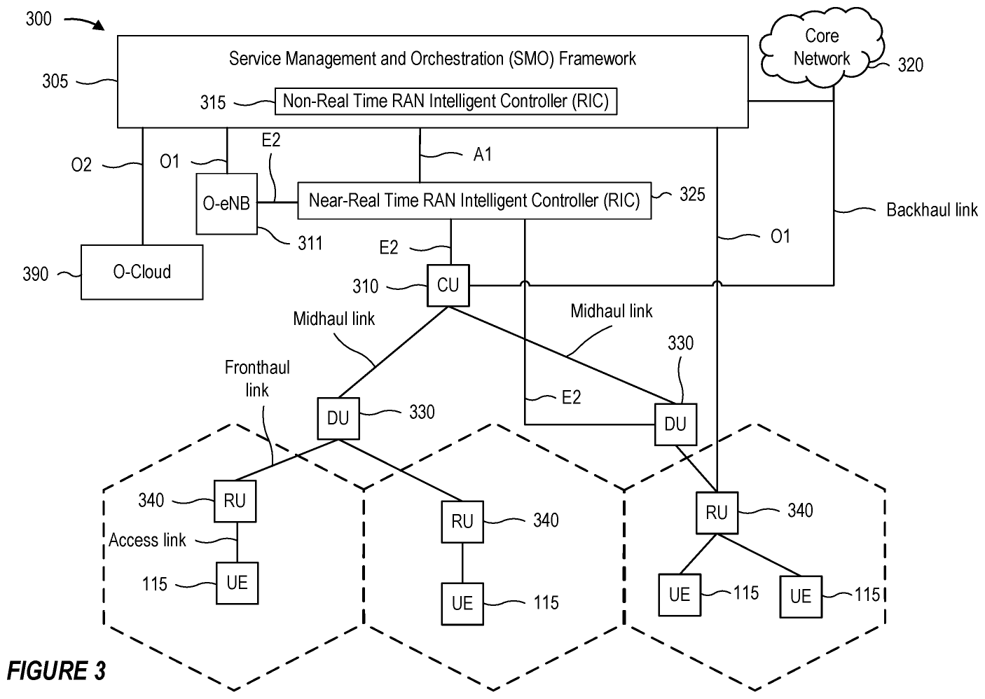

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RUs 340 can be implemented to handle over the air (OTA) communication with one or more UEs 115. In some implementations, real-time and non-real-time aspects of control and user plane communication with the RUs 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUS 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a location management function (LMF), a sensing management function (SnMF), a server, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

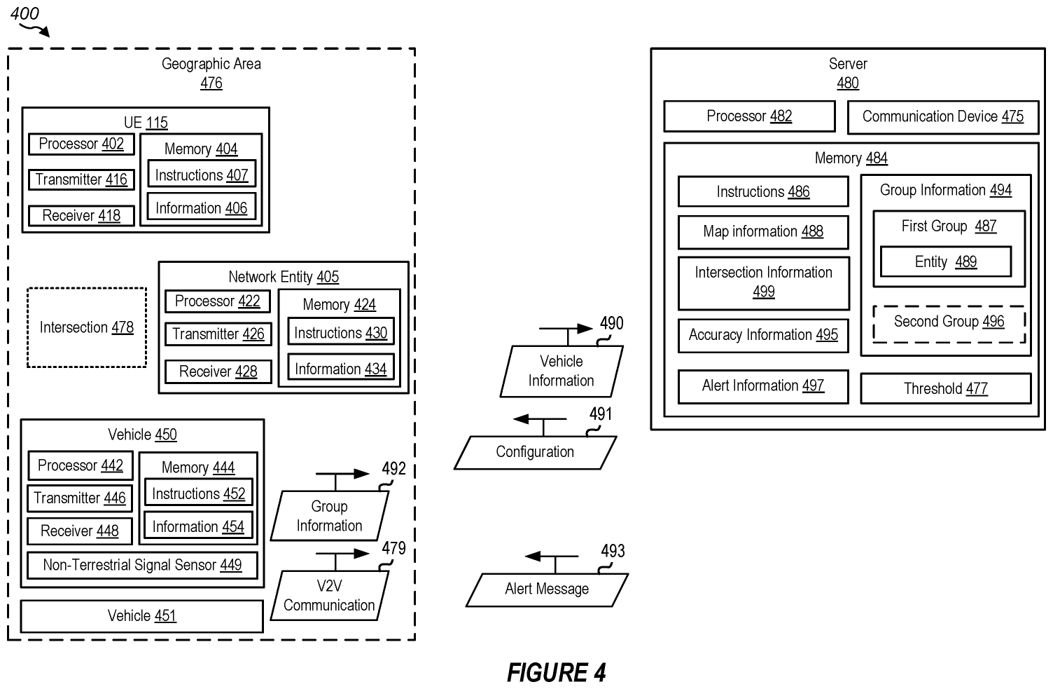

FIG. 4 is a block diagram of an example wireless communications system 400 that supports a safety system according to one or more aspects. In some examples, wireless communications system 400 may implement aspects of wireless network 100. Additionally, or alternatively, wireless communications system 400 may include or correspond to a vulnerable road user (VRU) alert system. Wireless communications system 400 includes UE 115, vehicle 450, vehicle 451, a network entity 405, and a server 480. In some implementations, vehicle 450 or 451 may include or correspond to UEs 115i, 115j. 115k to FIG. 1. It is noted that vehicle 450 and 451 may also be referred to as a mobile entity—e.g., vehicle 450 is a first mobile entity and vehicle 451 is a second mobile entity. In some implementations, network entity 405 and server 480 may be individually or collectively referred to as a network, a network device, or a network system (e.g., a safety system). Although one UE 115, two vehicles 450 and 451, one network entity 405, and one server 480 are illustrated, in some other implementations, wireless communications system 400 may generally include multiple UEs 115, one or more vehicles 450, 451, multiple network entities 405, multiple servers 480, or a combination thereof.

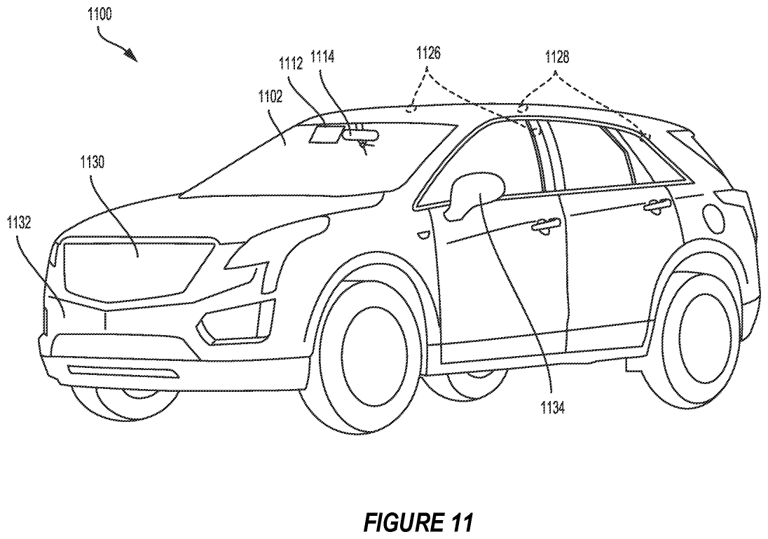

Although one UE 115 and one base station 105 are illustrated, in some other implementations, wireless communications system 400 may generally include multiple UEs 115, multiple base stations 105, or a combination thereof. In some implementations, UE 115 may be a vehicle, such as described further herein at least with reference to FIG. 11. Additionally, or alternatively, UE 115 may include or correspond to a device of a pedestrian (e.g., a VRU). For example, the device of the pedestrian may include or correspond to UE 115a, 115b, 115c. 115d, 114h. 115x, or 115y, as illustrative, non-limiting examples.

In some implementations, wireless communication system 400 includes a V2X wireless communication system. V2X is a communication system in which information is passed between a vehicle and other entities within the wireless communication network that provides the V2X services. The V2X services may include services for Vehicle-to-Vehicle (V2V), Vehicle-to-Pedestrian (V2P), Vehicle-to-Infrastructure (V2I), and Vehicle-to-Network (V2N). One or more V2X standards aim to develop or support an Advanced Driver Assistance System (ADAS), which assist a driver with critical decisions, such as lane changes, speed changes, overtaking speeds, etc. Low latency communications may be used in V2X and, are therefore suitable for precise positioning. For example, positioning techniques, such as time of arrival (TOA), time difference of arrival (TDOA) or observed time difference of arrival (OTDOA), or any other cellular positioning technique, may be enhanced using assistance from V2X.

In general, there may be at least two modes of operation for V2X services, as defined in Third Generation Partnership Project (3GPP) TS 23.285. One mode of operation uses direct wireless communications between V2X entities when the V2X entities are within range of each other. The other mode of operation uses network based wireless communication between entities. The two modes of operation may be combined or other modes of operation may be used if desired.

The wireless communication of a V2X wireless communication system may be over Proximity-based Services (ProSc) Direction Communication (PC5) reference point as defined in 3GPP TS 23.303, and may use wireless communications under Institute of Electrical and Electronics Engineers (IEEE) 1609, Wireless Access in Vehicular Environments (WAVE), Intelligent Transport Systems (ITS), and IEEE 802.11p, on the ITS band of 5.9 GHZ, or other wireless connections directly between entities.

In some implementations, wireless communications system 400 is associated with a geographic area 476. Geographic area 476 may includes one or more roads that include at least one intersection 478. Intersection 478 may be any type of intersection, such as a “T” intersection, a “+” intersection, a “Y” intersection, a roundabout intersection, or other type of intersection. Additionally, the one or more roads may be associated with multiple paths that each lead toward or into intersection 478. For example, the one or more paths may be configured for vehicular traffic, pedestrian traffic, or a combination thereof. The one more roads or one or more paths may be linear, non-linear, curved, or a combination thereof. To illustrate, the one or more paths may be associated with a road, a car lane, a bus lane, a bike lane, a sidewalk, or a combination thereof, as illustrative, non-limiting examples. In some implementations, intersection 478 may be associated with a geo-fenced portion of geographic area 476.

In some implementations, UE 115, network entity 405, vehicle 450, and vehicle 451 may be positioned within geographic area 476. Although each of UE 115, network entity 405, vehicle 451, and vehicle 450 is described and shown as being positioned within geographic area 476, in other implementations, one or more of UE 115, network entity 405, vehicle 450, or vehicle 451 may be positioned outside of geographic area 476. Additionally, or alternatively, UE 115, vehicle 450, or vehicle 451 may be traveling towards or positioned within intersection 478. In some implementations, UE 115, vehicle 450, vehicle 451, or a combination thereof, are mobile devices. Network entity 405 may include a base station, such as base station 105, an access point, a roadside unit, another UE or vehicle, or part of a core network, such as core network 130. Network entity 405 may be stationary or mobile. Server 480 may include a server, base station 105, core network 130, or other device or system. For example, server 480 includes a car 2 cloud (C2C) server. In some implementations, server 480 is or includes LMF 131.

In some implementations, UE 115, vehicle 450, or vehicle 451 is configured to communicate with another of UE 115, vehicle 450, or vehicle 451 using a sidelink (SL) link/interface (e.g., using sidelink communication). Additionally, or alternatively, UE 115, vehicle 450, vehicle 451, or a combination thereof, is configured to communicate with network entity 405 using a sidelink (SL) link/interface (e.g., using sidelink communication) or a Uu link/interface (e.g., using Uu communication). Server 480 may be in communication with (e.g., communicatively coupled to) UE, vehicle 450, or network entity 405 via a cellular network. Server 480 may be configured to be aware of a situational awareness (e.g., a position, a heading, a speed, etc.) of UE 115 or vehicle 450 based on information, such as a vehicle/VRU,) based on a safety message, such as a basic safety message (BSM) message (for vehicle 450), a personal safety message (PSM) message (for UE 115), a collective perception message (CPM), or a combination thereof, as illustrative, non-limiting examples. Additionally, or alternatively, server 480 may be aware of the maps of or associated with geographic area 476, such as a map that indicates a nature of local intersections (e.g., 478), stop sign, traffic lights in geographic area, or other information, as illustrative, non-limiting examples. For example, a map or map data associated with geographic area 476 may include or correspond to map information 488, as described further herein.

In some implementations, a BSM may include or indicate information (e.g., BSM information), such as position, motion, control, size, an event, or a combination thereof. The position may include or indicate latitude, longitude, elevation, positional accuracy. The motion may include or indicate a transmission setting, a speed, a heading, a steering wheel angle, an acceleration (e.g., a longitudinal acceleration, a lateral acceleration, a vertical acceleration, a yaw rate, or a combination thereof), or a combination thereof. The control may include or indicate a brake system status, such as braking or not braking, as illustrative, non-limiting examples. The size may include or indicate a vehicle size, such a weight, a length, a width, a height, a maximum number of passengers, or a combination thereof, as illustrative, non-limiting examples. The event may include, indicate, or be associated with hazard lights, a stop line violation, ABS, traction control, stability control, hazardous materials, emergency response, hard braking, lights changed, wipers changed, a flat tire, a disabled vehicle, an air bag deployment, or a combination thereof, as illustrative, non-limiting examples. In some implementations, the CP may include or indicate information about a detected object, an onboard sensor, or a combination thereof. The CPM may include, correspond to, or be defined by and ETSI ITS Intelligent Transport System (ITS) standard. As an illustrate, non-limiting example, the CPM may include or indicate an object ID, an object description, a local sensor perception, a neighboring vehicle perception, an RSU perception, or a combination thereof.

UE 115 may include a device, such as a mobile device or a vehicle. In some implementations, UE 115 is a device that corresponds to a VRU. UE 115 may include a variety of components (such as structural, hardware components) used for carrying out one or more functions described herein. For example, these components may include one or more processors 402 (hereinafter referred to collectively as “processor 402”), and one or more memory devices 404 (hereinafter referred to collectively as “memory 404”). In some implementations, UE 115 may include an interface (e.g., a communication interface) that includes transmitter 416, receiver 418, or a combination thereof. Processor 402 may be configured to execute instructions 407 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 407 and information 406. Information 406 may include capability information, location information, travel information, or a combination thereof. Information 406 may include or indicate a location or position (e.g., latitude, longitude, elevation, etc.), position accuracy, a heading, a speed, a velocity, an altitude, a device state, a path history, a predicted path, a planned plan, an ID, a time, a steering wheel angle, acceleration, Yaw rate, brake system status, a device or vehicle size (e.g., a length, a width, a height, a weight, etc.), an event flag, or a combination thereof, as illustrative, non-limiting example.

UE 115 includes one or more transmitters 416 (hereinafter referred to collectively as “transmitter 416”), and one or more receivers 418 (hereinafter referred to collectively as “receiver 418”). Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105, network entity 405, vehicle 450, or another UE 115. In some implementations, transmitter 416 and receiver 418 may be integrated in one or more transceivers. Additionally, or alternatively, transmitter 416 or receiver 418 may include or correspond to one or more components of UE 115 described with reference to FIG. 2

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with the base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, UE 115 includes a non-terrestrial signal sensor. For example the non-terrestrial signal sensor may include one or more global navigation satellite system (GNSS) sensors. A GNSS may include or correspond to a satellite constellation that provides positioning, navigation, and timing (PNT) services on a global or regional basis. Additionally, or alternatively, UE 115 may include one or more components as described herein with reference to UE 115. In some implementations, UE 115 is a 5G-capable UE, a 6G-capable UE, or a combination thereof.

Vehicle 450 may include a device, such as a mobile device or a vehicle. For example, vehicle 450 may include or correspond to UEs 115i, 115j. 115k of FIG. 1. In some implementations, vehicle 450 may include or correspond to a vehicle as described with reference to FIG. 11 or a network entity as described with reference to FIG. 13. Vehicle 450 may include a variety of components (such as structural, hardware components) used for carrying out one or more functions described herein. For example, these components may include one or more processors 442 (hereinafter referred to collectively as “processor 442”), one or more memory devices 444 (hereinafter referred to collectively as “memory 444”), one or more transmitters 416 (hereinafter referred to collectively as “transmitter 416”), one or more receivers 481 (hereinafter referred to collectively as “receiver 418”), and one or more non-terrestrial signal sensors 449 (“non-terrestrial signal sensor 449”). Processor 442 and memory 444 may include or correspond to processor 402 and memory 404 respectively. In some implementations, vehicle 450 may include an interface (e.g., a communication interface) that includes transmitter 446, receiver 448, or a combination thereof. Transmitter 446 and receiver 448 may include or correspond to transmitter 416 and receiver 418, respectively. Processor 442 may be configured to execute instructions 452 stored in memory 444 to perform the operations described herein. In some implementations, processor 442 includes or corresponds to one or more of receive processor 258, transmit processor 264, and controller 280, and memory 444 includes or corresponds to memory 282.

Memory 444 includes or is configured to store instructions 452 and information 454. Instructions 452 may include or correspond to instructions 407. Information 454 may include or correspond to information 406. Information 454 may include capability information, location information, travel information, or a combination thereof. Additionally, or alternatively, information 454 may include or indicate a location or position (e.g., latitude, longitude, elevation, etc.), position accuracy (e.g., HEPE), a dilution of precision (DOP) or a component thereof, a heading, a speed, a velocity, an altitude, a device state, a path history, a predicted path, a planned plan, an ID, a time, a steering wheel angle, acceleration, Yaw rate, brake system status, a device or vehicle size (e.g., a length, a width, a height, a weight, etc.), an event flag, or a combination thereof, as illustrative, non-limiting example.

Transmitter 446 is configured to transmit reference signals, control information and data to one or more other devices, and receiver 448 is configured to receive references signals, synchronization signals, control information and data from one or more other devices. For example, transmitter 446 may transmit signaling, control information and data to, and receiver 448 may receive signaling, control information and data from, base station 105, network entity 405, another vehicle 450, or UE 115. In some implementations, transmitter 446 and receiver 448 may be integrated in one or more transceivers. Additionally, or alternatively, transmitter 446 or receiver 448 may include or correspond to one or more components of UE 115 described with reference to FIG. 2.

In some implementations, vehicle 450 may include one or more antenna arrays. The one or more antenna arrays may be coupled to transmitter 446, receiver 448, or a communication interface. The antenna array may include multiple antenna elements configured to perform wireless communications with other devices, such as with the base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of vehicle 450. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Non-terrestrial signal sensor 449 may include one or more global navigation satellite system (GNSS) sensors. A GNSS may include or correspond to a satellite constellation that provides positioning, navigation, and timing (PNT) services on a global or regional basis. In some implementations, non-terrestrial signal sensor 449 may include or correspond to transmitter 416, receiver 418, or a combination thereof.

In some implementations, non-terrestrial signal sensor 449 is configured to perform a measurement or generate a report, such as a GNSS sensor position report. For example, non-terrestrial signal sensor 449 may be configured to generate the report at a regular interval, such as 1 Hertz (Hz) (e.g., once per second). Additionally, or alternatively, each CNSS sensor measurement may include multiple interdependent dilution of precision (DOP) scalars, ephemeris data associated with a satellite vehicle correction, or a combination thereof. In some implementations, the DOP scalars may include a horizontal DOP (2D-HDOP), a position DOP (3D-DOP), a vertical DOP (VDOP), a time DOP (TDOP), or a combination thereof. The 2D-HDOP may be associated with latitude, longitude, or a combination thereof, the 3D-PDOP may be known as a spherical DOP, the VDOP may be associated with altitude, and the TDOP may be associated with time.

Vehicle 451 may include or correspond to vehicle 450. For example, vehicle 451 may include one or more components as described with reference to vehicle 450. Additionally, or alternatively, vehicle 451 may be configured to perform one or more operations as described with reference to vehicle 450. It is also noted that vehicle 450 may be configured to also perform one or more operations as described with reference to vehicle 451.

Vehicle 450 or 451 may include one or more components as described herein with reference to UE 115, the vehicle of FIG. 11, or the network entity of FIG. 13. In some implementations, vehicle 450 or 451 is a 5G-capable vehicle, a 6G-capable vehicle, or a combination thereof.

Network entity 405 may include a device, such as a base station, a roadside unit, a node, or another UE. Network entity 405 may be a mobile device or a stationary device. Network entity 405 may include a variety of components (such as structural, hardware components) used for carrying out one or more functions described herein. For example, these components may include one or more processors 422 (hereinafter referred to collectively as “processor 422”), and one or more memory devices 424 (hereinafter referred to collectively as “memory 424”). In some implementations, network entity 405 may include an interface (e.g., a communication interface) that includes transmitter 426, receiver 428, or a combination thereof. Processor 422 may be configured to execute instructions 430 stored in memory 424 to perform the operations described herein. In some implementations, processor 422 includes or corresponds to one or more of receive processor 238, transmit processor 220, and controller 240, and memory 424 includes or corresponds to memory 242.

Memory 424 includes or is configured to store instructions 430 and information 434. Information 434 may include or correspond to information 406 or 454. For example, network entity 405 may be configured to receive, from vehicle 450, vehicle information 490 or group information, each of which may include or indicate information 406.

Network entity 405 includes one or more transmitters 426 (hereinafter referred to collectively as “transmitter 426”), and one or more receivers 428 (hereinafter referred to collectively as “receiver 428”). Transmitter 426 is configured to transmit reference signals, control information and data to one or more other devices, and receiver 428 is configured to receive references signals, synchronization signals, control information and data from one or more other devices. For example, transmitter 426 may transmit signaling, control information and data to, and receiver 428 may receive signaling, control information and data from, base station 105, UE 115, vehicle 450, another network entity 405, or server 480. In some implementations, transmitter 426 and receiver 428 may be integrated in one or more transceivers. Additionally, or alternatively, transmitter 426 or receiver 428 may include or correspond to one or more components of base station 105 described with reference to FIG. 2.

In some implementations, network entity 405 may include one or more antenna arrays. The one or more antenna arrays may be coupled to transmitter 426, receiver 428, or a communication interface. The antenna array may include multiple antenna elements configured to perform wireless communications with other devices, such as with UE 115 or base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams.

Alternatively, one or more sets of antenna elements of the antenna array may be configured to concurrently generate multiple beams, for example using multiple RF chains of network entity 405. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Network entity 405 may include one or more components as described herein with reference to UE 115 or base station 105. In some implementations, network entity 405 is a 5G-capable network entity, a 6G-capable network entity, or a combination thereof.

Server 480 may include a variety of components (such as structural, hardware components) used for carrying out one or more functions described herein. For example, these components may include one or more processors 482 (hereinafter referred to collectively as “processor 482”), one or more memory devices 484 (hereinafter referred to collectively as “memory 484”), and one or more communication devices 475 (hereinafter referred to collectively as “communication device 475”). In some implementations, server 480 may include an interface (e.g., a communication interface) that includes communication device 475. Processor 482 may be configured to execute instructions 486 stored in memory 484 to perform the operations described herein. In some implementations, processor 482 includes or corresponds to one or more of receive processor 238, transmit processor 220, and controller 240, and memory 484 includes or corresponds to memory 242.

Memory 384 includes or is configured to store instructions 486, map information 488, intersection information 499, group information 494, accuracy information 495, alert information 497, and one or more thresholds 477 (hereinafter referred to collectively as “threshold 477”). Map information 488 may include or indicate aspects or features of geographic area 476. Map information 488 may include or indicate roads, intersections, traffic control devices, geographic features, hazards, or a combination thereof, as illustrative, non-limiting examples. In some implementation, map information 488 may include intersection information 499. For example, map information 488 may include or indicate an intersection (e.g., 478). Additionally, or alternatively, map information 488 may include or indicate a population density, a traffic density, or a combination thereof. The population density may include or indicate a designation or a type of an area or a region based on a concentration or distribution of a population. The designation or the type associated with population may include rural, semi-rural, urban, suburban, or city center, as illustrative, non-limiting examples. The traffic density may include or indicate a designation or a type of traffic. The designation or the type of traffic may include recurring congestion, non-recurring congestion, light, medium, heavy, gridlock, emergency, severe, serious, moderate, or minimal, as illustrative, non-limiting examples. The designation or the type of traffic may vary or change with time.

In some implementations, map information 488 and may include meta data that indicates a population density, a traffic density, that is associate with intersection 478, or a combination thereof. To illustrate, the metadata may include intersection information 499. Although described as being included in server 480, in other implementations, map information 488 may be stored in a database that remote or accessible to server 480.

Intersection information 499 may be associated with one or more intersections, such as intersection 478. For example, intersection information 499 may include or indicate information that defines or characterizes an intersection region associated with intersection 478. The intersection region may be defined to be the same or a different size or shape as intersection 478. In some implementations, intersection information 499 may indicate or define, for intersection 478, the intersection region associated with intersection 478, or a both, a size, a shape, an origin, a length, a road, a traffic control device, a geographic feature, a hazard, or a combination thereof, as illustrative, non-limiting examples. In some implementations, intersection information 499 may include or define a geo-fenced area that is associated with an intersection (e.g., 478).

Group information 494 includes or indicates one or more groups of mobile entities (which may also be referred to as on or more platoons of mobile entities). For example, group information 494 may include a first group 487 and, optionally, a second group 496. Each group 487 or 496 may include or indicate at least one entity, such as a represented entity 489 of first group 487. In some implementations, group information 494 may include or indicate, for a group, a group configuration (e.g., 491) of the group, vehicle information 490 of an entity (e.g., 489) of the group, group information 492 of the group, or a combination thereof. In some implementations, server 480 may be configured to combine multiple groups (e.g., 487 and 496) into a combined group. Additionally, or alternatively, server 480 may be configured to divide a group, such as first group 487, into two or more sub-group.

Accuracy information 495 includes or indicates an accuracy of a position of a mobile entity, such as UE 115, vehicle 450, or vehicle 451. Alert information 497 may include or indicate a collision potential between a mobile entity and an object. For example, alert information 497 may indicate a collision potential exists for vehicle 450, such as a collision potential between vehicle 450 and an object (e.g., UE 115).

Threshold 477 may include or indicate one or more values, one or more ranges, or a combination thereof. Threshold 477 may be associated with a time, a duration, a heading, a distance, or a combination thereof.

In some implementations, wireless communications system 400 implements a 5G NR network. For example, wireless communications system 400 may include multiple 5G-capable UEs 115, multiple 5G-capable vehicles 450, 451, multiple 5G capable network entities 405, or multiple 5G-capable base stations 105, such as UEs and base stations configured to operate in accordance with a 5G NR network protocol such as that defined by the 3GPP. In some other implementations, wireless communications system 400 implements a 6G network.

In some implementations, wireless communications system 400 (e.g., server 480) is configured to group one or more mobile devices, such as one or more vehicles, into a group. For example, the one or more mobile devices may be grouped based on map information 488. The group may be configured to transmit, to server 480, one or more safety messages for the group. For example, the group may transmit one or more safety message for the group to server 480 in lieu of each mobile device of the group transmitting one or more safety message for the mobile device to server 480.

In some implementations, server 480 receives a safety message, such as a BSM, from each vehicle of a plurality of vehicles. Accordingly, server 480 has knowledge of a speed, a location, a heading, or a combination thereof, for each vehicle of the plurality of vehicles. Server 480 may group one or more vehicles of the plurality of vehicles into a group. For example, the group may include or correspond to first group 487. Server 480 may receive one or more safety messages for the group based on the group being configured. In some implementations, the one or more safety messages for the group may not include or indicate a speed or heading and server 480 may use speed information or heading information for the group that is based on one or more BSM received from vehicles of the group prior to formation of the group. In some other implementations, the one or more safety messages for the group may include or indicate the speed or heading of the group to server 480 one time or semi-statically (e.g., every 5th message). Although described as speed or heading information, other information or parameters may be communicated in a similar manner if such information or parameters are not expected to change significantly for the group over time.

In some implementations, server 480 may generate the group (e.g., select the one or more vehicles or a number of vehicles for the group) based on map information 488. To illustrate, server 480 may select the one or more vehicles for the group and may generate configuration information, such as configuration 491, to transmit to at least one vehicle of the group. Server 480 may select the group or generate the group (e.g., configuration 491) based on map information 488, such as whether map information 488 indicates that an area associated with the one or more vehicles is rural, semi-urban, or urban. Additionally, or alternatively, server 480 may select the group or generate the group (e.g., configuration 491) based on a population density, a traffic density, or a combination thereof, indicated by map information 488.

In some implementations, server 480 may configure the group such that one vehicle of the group is designated as a leader of the group. The leader of a group may be an initial vehicle of the group in a direction of travel, a last vehicle of the group in a direction of travel, or another vehicle in the group other than the initial vehicle or the last vehicle. The leader of the group may be configured to transmit one or more safety messages to server 480. For example, the leader may transmit the one or more safety messages on behalf of the group such that other vehicles of the group do not need to transmit safety messages to server 480. In some such implementations, the designation of a leader and the configuration of the leader transmitting one or more safety message on behalf of the group (such that other vehicles of the group do not need to transmit safety messages to server 480) may be performed based on map information 488 that indicates that an area associated with the one or more vehicles is rural or semi-urban.

In some implementations, the one or more safety messages transmitted by the leader may include BSM information of the leader, and may not include BSM information of another vehicle of the group. In some other implementations, the one or more safety messages transmitted by the leader may include information associated with another vehicle of the group. For example, the one or more safety messages transmitted by the leader may include safety information (e.g., BSM information) of the other vehicle, CPM information from the other, distance or position information associated with the other vehicle, or a combination thereof. Additionally, the one or more safety message may include safety information of the leader. To illustrate, the one or more safety messages transmitted by the leader may include BSM information of the leader and BSM information of at least one other vehicle of the group other than the leader.

In some implementations, server 480 may configured the group based on a pattern, such as a preconfigured pattern. For example, the pattern may include or indicate that each vehicle of the group is configured to transmit BSM information of the vehicle in a round-robin fashion—e.g., one after the other. As another example, the pattern may include or indicate that an initial vehicle and a last vehicle of the group alternat transmitting its BSM information. In some such implementation, a leader of the group may or may not be designated by server 480. In some implementations, server 480 may select the pattern based on map information 488 that indicates that an area associated with the one or more vehicles is urban.

By configuring the group to transmit one or more safety messages for the group, an amount of OTA resources may be reduced as compared to each vehicle of the group transmitting its own safety messages. Additionally, or alternatively, the one or more safety messages transmitted by the group may not negatively impact VRU safety—e.g., server 480 acquires sufficient information based on the one or more messages from the group to identify a potential collision. Additionally, configuring the group to transmit one or more safety messages for the group, wireless communications system 400 (e.g., server 480) may not have to a perform collision potential calculation for every individual vehicle in the group. Stated differently, wireless communications system 400 (e.g., server 480) may perform collision potential for the group, which enable scaling of performing collision potential calculations.

In some implementations, wireless communications system 400 (e.g., server 480) is configured to determine a position or interaction of the group with respect to intersection 478 or other geo-fenced zone. For example, server 480 may determine an entry (e.g., a time of entry) of the group into intersection, an exit (e.g., a time of exit) of the group from intersection 478, or a combination thereof. To illustrate, server may determine the entry or the exit based on map information 488, intersection information 499, accuracy information, or a combination thereof. Server 480 may use the entry or the exit of the group to identify or determine a potential collision. To determine the entry or the exit, server 480 may use information included in or indicated by one or more safety messages for the group.

In some implementations, server 480 may use safety information from a single member of the group to determine the entry of the group or the exit of the group. The safety information may include a speed, a heading, a distance or offset between two vehicle of the group, or a combination thereof, as illustrative, non-limiting examples. The safety information may be based on or included in a safety message received from the leader of the group, such as safety information (e.g., speed or heading) that is received once or semi-statically, as illustrative, non-limiting examples. As an illustrative example, server 480 may use a speed and a heading reported by one vehicle of the group to determine a time of entry into intersection 478 (e.g., a geo-fenced zone). As another example, server 480 may calculate a time of exit based on a speed, a distance between two vehicles of the group (e.g., an initial vehicle and a last vehicle), a position of a reporting vehicle (e.g. the leader), or a combination thereof. As an illustrative, non-limiting example, server 480 may determine the entry time of the group into a geo-fenced zone (E.g., intersection 478) based on safety information received from the leader of the group that is the initial vehicle, and may calculate the exit time based on a length of the group and a relative speed of another vehicle (e.g., the last vehicle of the group) with respect to the leader.

In some implementations, server 480 may determine a time of entry of the group into intersection 478 (e.g., a geo-fenced zone) based on a safety message from an initial vehicle of the group. Additionally, or alternatively, server 480 may determine a time of exit of the group from intersection 478 (e.g., a geo-fenced zone) based on a safety message from a last vehicle of the group.

In some implementations, wireless communications system 400 (e.g., server 480) is configured to provide an alert, such as alert message 493, to the group. For example, server 480 may determine that one or more vehicles of the group have a collision potential. Additionally, or alternatively, server 480 may determine that one or more vehicles of the group do not have a collision potential. In some implementations, server 480 may determine whether or not a collision potential exists (with another object within a zone) based on an entry time of the group into or an exit time of the group from the zone, such as a geo-fenced zone (e.g., intersection 478).

In some implementations, server 480 may determine a collision potential for the group and may transmit the alert to at least one member of the group. For example, server 480 may transmit the alert to the leader and the leader may notify one or more other vehicles in the group of the collision potential. To illustrate, the leader may use a sidelink communication to indicate to at least one other vehicle of the collision potential. As another example, server 480 may transmit the alert to each vehicle of the group.

In some implementations, server 480 may transmit the alert to one or more vehicles that have a collision potential. For example, server 480 may determine that the last vehicle of the group has the collision potential and may only transmit the alert to the last vehicle. Additionally, or alternatively, server 480 may transmit the alert to at least one vehicle that may be impacted due to a speed update likely to be performed by the vehicle having the position potential. For example, server may determine that the second to last vehicle has a collision potential and may transmit an alert to the last vehicle to notify the last vehicle that the second to last vehicle has the collision potential and is likely to change (e.g., reduce speed).

In some implementations, wireless communications system 400 (e.g., server 480) is configured to combine groups or divide a group. For example, server 480 may be configured to sub-divide a group into multiple sub-groups. Server 480 may sub-divide the group based on map information 488. To illustrate, server 480 may divide the group into a number of smaller groups (e.g., sub-groups) based on map information 488 indicating that an area of the group is semi-rural. In some implementations, one sub-group may be designated as a leader and may transmit safety messages on behalf of multiple sub-groups. In some other implementations, two or more sub-groups may transmit safety messages to server 480 based on a pattern, such as a pattern (e.g., round robin, alternating, etc.) indicated by server 480. In some other implementations, each sub-group may be designated a leader of the sub-group and the leader of the sub-group may transmit one or more safety messages on behalf of the sub-group to server 480. In some such implementations, dividing the group into multiple sub-groups may increase the granularity of safety messages being reported by each smaller group for safety purposes, while not significantly increasing the overall amount of safety message reporting (e.g., without significantly increasing a safety message overhead). Additionally, or alternatively, dividing the group into multiple sub-groups may account for situations or circumstances in which each vehicle of the group do not have the same, a uniform, or a substantially uniform speed or heading.

In some implementations, server 480 may be configured to combine multiple groups into a combined group. The combined group may be designated with a leader vehicle which is configured to transmit one or more safety messages on behalf of the combined group. Server 480 may combine groups based on map information 488. To illustrate, server 480 may combine groups, such as first group 487 and second group 496, based on map information 488 indicating that an area of the group is rural. In such rural situations, a collision potential is low and combining the groups to form a combined group may reduce an amount of safety message transmission.

In some implementation, one or more mobile entities may be configured to operate with a positioning system, such as a GNSS. For example, the one or more mobile entities may include UE 115, vehicle 450, or vehicle 451. Each mobile entity of the one or more mobile entities may include a non-terrestrial signal sensor, such as non-terrestrial signal sensor 449. The non-terrestrial signal sensor may be configured to perform a measurement or generate a report, such as a GNSS sensor position report. For example, the non-terrestrial signal sensor may be configured to generate the report at a regular interval, such as 1 Hz (e.g., once per second). Additionally, or alternatively, each GNSS sensor measurement may include multiple interdependent DOP scalars, ephemeris data associated with a satellite vehicle correction, or a combination thereof. In some implementations, the DOP scalars may include a 2D-HDOP, a 3D-DOP, a VDOP, a TDOP, or a combination thereof.

In some implementations, a mobile entity that includes the non-terrestrial signal sensor may be configured to provide or indicate, to another device or entity, one or more DOP scalars. Additionally, or alternatively, the mobile entity may determine a level of accuracy based on the one or more DOP scalars. For example, the mobile entity may determine whether the one or more DOP scalars are associated with a high level of accuracy or a low level of accuracy. In some implementations, the mobile entity may determine the level of accuracy based on 2D-HDOP, 3D-DOP, or a combination thereof, as illustrative, non-limiting examples.

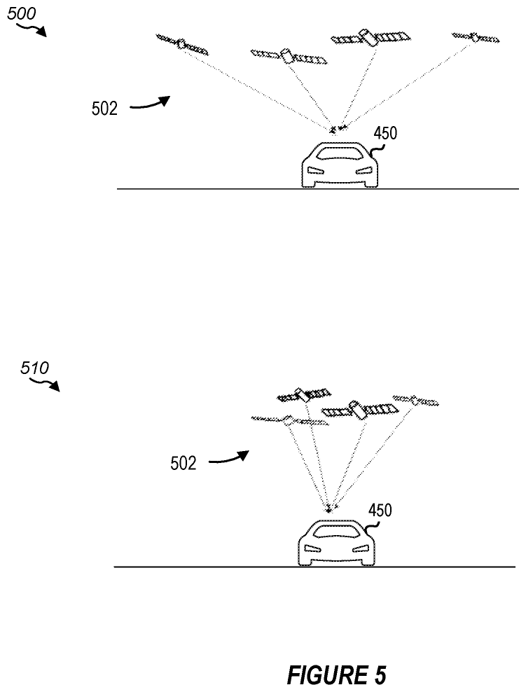

Referring to FIG. 5. FIG. 5 is a diagram illustrating examples of dilution of precision scenarios according to one or more aspects. For example, FIG. 5 shows a first example 500 having low DOP (e.g., a high level of accuracy) and a second example 510 having high DOP (e.g., a low level of accuracy). Each of examples 500 and 510 includes a set of satellite vehicles 502 and vehicle 450. Each satellite vehicle of the set of satellite vehicles 502 is configured to transmit a signal that is received by non-terrestrial signal sensor 449 of vehicle 450.

Referring to first example 500, vehicle 450 receives signals from the set of satellite vehicles 502 which are spread out such that vehicle 450 determines low DOP. Referring to second example 510, vehicle 450 receives signals from the set of satellite vehicles 502 which are less spread out as compared to first example. Accordingly, vehicle 450 of second example 510 determines high DOP. As shown in second example 510, the set of satellite vehicles 502 is clustered closer together as compared to the set of satellite vehicles 502 as shown in first example 500. However, this is for case of explanation and it is noted that the set of satellites vehicles 502 of first example 500 may produce high DOP with respect to vehicle 450, such as in a GNSS impaired areas or metropolitan test environments where there may be large HEPE (Horizontal Errors Position Estimates) due to satellite vehicle signal occlusion and multipath. To illustrate, in a metropolitan environment in which vehicle 450 is on a street that neighbors tall buildings (e.g., skyscrapers), the tall buildings may occlude signals from one or more satellite vehicles of the set of satellite vehicles 502 of first example 500 such that the received signals produce high DOP.

Referring back to FIG. 4, the mobile entity may generate an indicator that indicates one or more DOP scalars determined by the mobile entity, a level of accuracy determined by the mobile entity based on the one or more DOP scalars, or a combination thereof. The mobile entity may transmit the indicator to server 480. For example, the mobile entity may include the indicator in a message, such as a safety message or position message. The message may include or correspond to vehicle information 490, group information 492, or V2V communication 479. In some implementations, the mobile entity includes the indicator in a BSM or PSM that is transmitted to server 480.

Server 480 may be configured to determine accuracy information 495 based on the received indicator. In some implementations, server 480 may determine an accuracy (or an error) of a position of the mobile entity based on the indicator—e.g. the level of accuracy. Additionally, or alternatively, server 480 may select an accuracy metric to determine the accuracy (or error) of a position of the mobile entity. For example, server 480 may select the accuracy metric as a HEPE based on historical position track or use the level of accuracy indicated by the received indicator. A high level of accuracy (low HDOP/PDOP) indicated by the indicator may result in server 480 determining that a position of the mobile entity is accurate. Alternatively, a low level of accuracy (high HDOP/PDOP) indicated by the indicator may result in server 480 determining that a position of the mobile entity is not accurate. In some implementations, server 480 may use the HEPE based on the indicator indicating the low level of accuracy. Server 480 may generate alert information 497 or alert message 493. For example, server 480 may determine a collision potential of the mobile entity based on a position of the mobile entity based on the accuracy metric.

In some implementations, an example of operation of wireless communications system 400 includes vehicle 450 transmitting vehicle information 490 to server 480. Vehicle information 490 may include a safety message, such as a BSM of vehicle 450. In some implementations, vehicle information 490 may include an indicator that indicates a level of accuracy, such as a level of accuracy determined by vehicle 450 based on one or more DOP scalars. Additionally, or alternatively vehicle 451 may transmit a safety message (e.g., 490) to server 480.

Server 480 may select one or more entities (e.g., 489) to be included in a group based on received vehicle information (e.g., 490). For example, server 480 may select vehicles 450 and 451 to be included in first group 487. In some implementations, server 480 may select one or more vehicles or generate the group based on map information 488. Additionally, or alternatively, server 480 may generate a configuration (e.g., 491) for the group based on the map information 488. For example, server 480 may generate the group or the configuration based on a population density, a traffic density, or a combination thereof, indicated by map information 488.

Server 480 may transmit configuration 491 that indicates the configuration for the group (e.g., 487). For example, server 480 may transmit configuration 491 to one or more vehicles included in the group.

Vehicle 450 may receive configuration 491 and, after receipt of configuration 491, may perform vehicle-to-vehicle communication with vehicle 451. For example, the vehicle-to-vehicle communication may include transmission or reception of V2V communication 479. Vehicle-to-vehicle communication 479 may include one or more BSMs, vehicle information, configuration information, or a combination thereof. In some implementations, the vehicle-to-vehicle communication 479 is exchanged using sidelink communication.

While vehicles 450 and 451 are configured as part of the group, vehicle 450 may transmit group information 492 to server 480. Group information 492 may include information for or representative of the group.

Server 480 may receive group information 492 and determine whether or not there is a potential collision within a zone based on the group information. The zone may include or correspond to intersection 478, intersection information 499, a geo-fenced area, or a combination thereof. The potential collision may be between at least one vehicle of the group and an object (e.g., a pedestrian, another mobile entity, UE 115, etc.) within the zone. To determine whether or not there is a potential collision, server 480 determines an entry time of the group into the zone, an exit time of the group from the zone, a time period that the group is in the zone, or a combination thereof. For example, server 480 may estimate, based on the group information, an entry time of the group into a zone. As another example, server 480 may estimate an exit time of the group from the zone. Based on a determination of a potential collision, server 480 transmits alert message 493 to the group.

In some implementations, configuration 491 of the group (e.g., 487) is applicable until the group exits the zone (e.g., intersection 478). After the group exits the zone, server 480 may reconfigure one or more vehicles of the expired group into a new group.

As described with reference to FIGS. 4, the present disclosure provides techniques for supporting a safety system. The techniques described provide processes, information, and signaling configuring one or more vehicles into a group for purposes of generating and reporting safety information (e.g., group information 492) to server 480. For example, the group or a vehicle of the group may report one or more safety messages (e.g., 492) that are representative of or applicable to the group. The one or more safety message that are representative of the group may reduce redundant messaging (e.g., that indicate a speed or a heading) from the vehicles of the group. Configuring the group and receiving one or more safety messages for the group may minimize over the air transmissions without impacting safety. The one or more safety message for the group may enable server 480 to provide an alert to an individual vehicle of the group without necessarily receiving a safety message from the individual vehicle while the individual vehicle is configured as part of the group. Additionally, the techniques may provide reduced overhead communications, efficient entity or group tracking, improved and more relevant safety alerts, improved power efficiency, a reduction in intersection accidents, or a combination thereof.

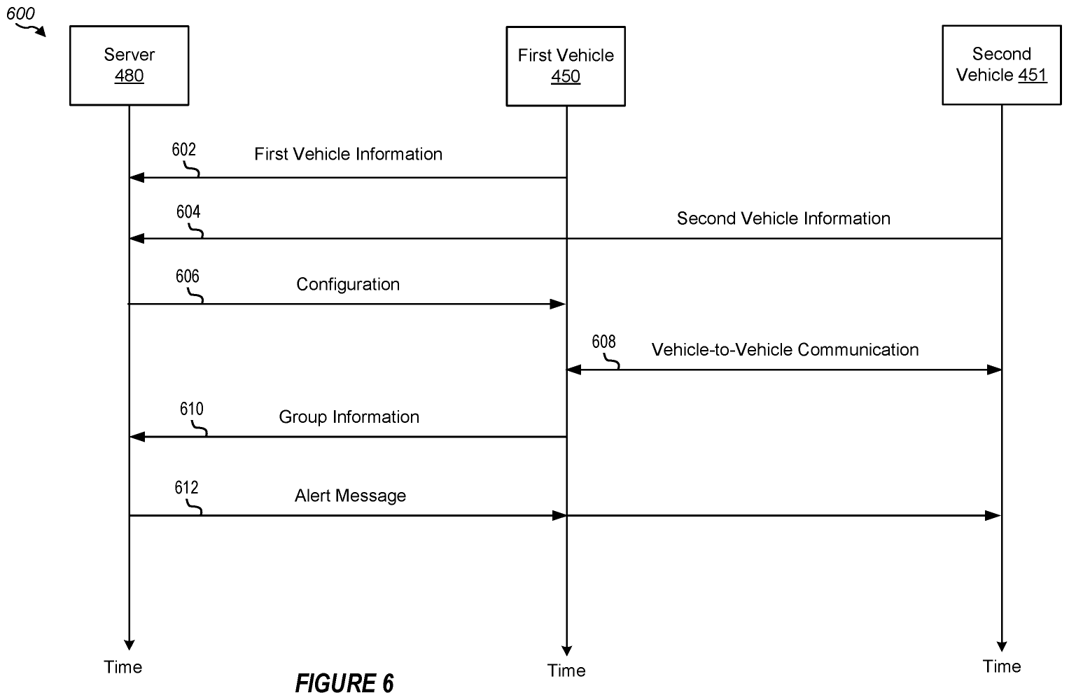

FIG. 6 is ladder diagram illustrating an example of operations of a safety system according to aspects of the present disclosure. As shown in FIG. 6, a wireless communication system 600 of the ladder diagram of FIG. 5 includes server 480, first vehicle 450, and second vehicle 451. Wireless communication system 600 may include or correspond to wireless communication system of FIG. 1 or wireless communication system 400. While FIG. 6 depicts two vehicles 450 and 451, wireless communication system 600 may include a single vehicle or more than two vehicles. Additionally, although wireless communication system 600 does not show a network entity (e.g., 405) or a UE (e.g., 115), in other implementation, wireless communication system 600 may include one or more a network entities (e.g., 405), one or more UEs (e.g., 115), or a combination thereof. In some implementations, one or more operations performed or descried with respect to server 480 may be performed by a controller, such as a centralized controller (e.g., core network 130 or a management function of core network).

During operation of wireless communication system 600, at 602, first vehicle 450 transmits first vehicle information to server 480. The first vehicle information may include or correspond to vehicle information 490.

At 602, second vehicle 451 transmits second vehicle information to server 480. The second vehicle information may include or correspond to vehicle information 490.

Server 480 may select multiple mobile entities to be included in a group. The group may include or correspond to first group 487. Server 480 may select the multiple mobile entities based on the first information, the second information, the map information, or a combination thereof. The map information may include or correspond to geographic area 476, intersection 478, map information 488, intersection information 499.

At 606, server 480 may transmit a configuration that includes or indicates group configuration information for a group. The configuration may include or correspond to configuration 491. Server 480 may transmit the configuration to one or more mobile entities included in the group. In some implementations, the group may include the first mobile entity and a second mobile entity.

At 608, first mobile entity 450 and second mobile entity 451 perform vehicle-to-vehicle communication. The vehicle-to-vehicle communication may include transmission or reception of V2V communication 479. Additionally, or alternatively, the vehicle-to-vehicle communication may include exchange of one or more BSMs, vehicle information, configuration information, or a combination thereof. In some implementations, the vehicle-to-vehicle communication includes sidelink communication.

At 610, first mobile entity 450 transmits group information. For example, the group information may include or correspond to group information 492.

Server 480 receives the group information and determines whether or not there is a potential collision within a zone based on the group information. The zone may include or correspond to intersection 478, intersection information 499, a geo-fenced area, or a combination thereof. The potential collision may be between at least one mobile entity of the group and an object (e.g., a pedestrian, another mobile entity, etc.) within the zone. To determine whether or not there is a potential collision, server 480 determines an entry time of the group into the zone, an exit time of the group from the zone, a time period that the group is in the zone, or a combination thereof. For example, server 480 may estimate, based on the group information, an entry time of the group into a zone. As another example, server 480 may estimate an exit time of the group from the zone.

At 612, server 480 transmits an alert message to the group. For example, the alert message may include or correspond to alert message 493. The alert information may be based on map information (e.g., 488 or 499). Server 480 may transmit the alert message to one or more vehicles of the group. Although FIG. 6 shows server 480 transmitting the alert message to both first vehicle 450 and second vehicle 451, in other implementations, server 480 may transmit the alert message to first vehicle 450 but not second vehicle 451, and vice versa.

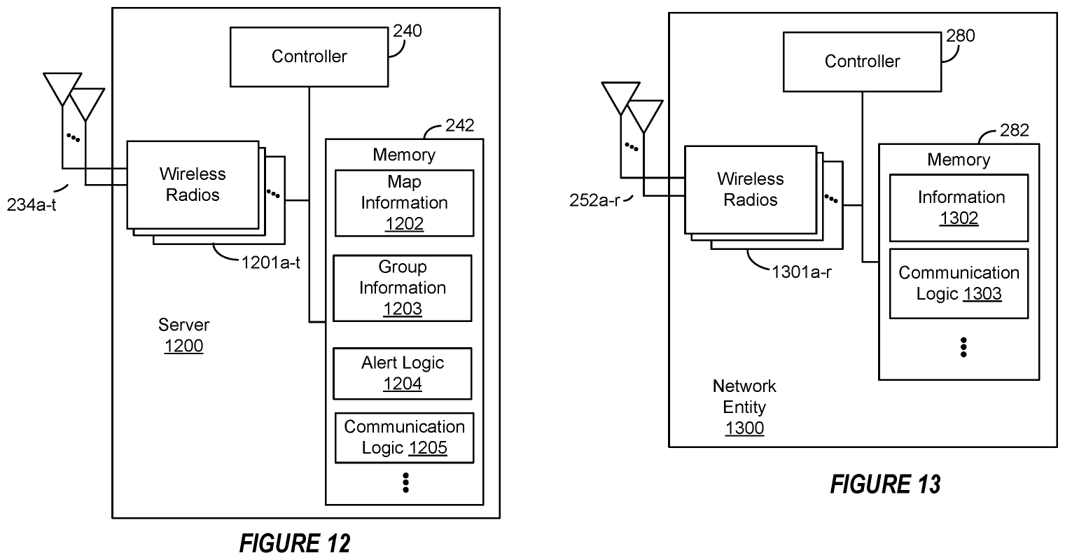

Referring to FIG. 7, FIG. 7 is a flow diagram illustrating an example process 700 that supports a safety system according to one or more aspects. Operations of process 700 may be performed by a server, such as core network 130 or server 480, base station 105, or network entity 405, or a server as described with reference to FIG. 12. For example, example operations of process 700 may enable the server to support a safety system.

At block 702, the server receives, from a first mobile entity, first information of the first mobile entity. For example, the first mobile entity may include or correspond to vehicle 450. The first information may include or correspond to information 454 or vehicle information 490.

At block 704, the server transmits, to the first mobile entity, a group configuration information. For example, the group configuration information may include or correspond to configuration 491, group information 494, or a combination thereof. The group configuration information may be generated based on map information and may indicate a group that includes the first mobile entity and a second mobile entity. For example, the group may include vehicle 450 and vehicle 451. Additionally, or alternatively, the group may be associated with first group 487 of group information 494. The map information may include or correspond to geographic area 476, intersection 478, map information 488, intersection information 499, or a combination thereof. In some implementations, the group configuration information indicates to for or establish the group. Additionally, or alternatively, the group configuration information may indicate a communication scheme between the group and the server.

At block 706, the server transmits alert information to the group. For example, the alert information may include or correspond to alert message 493 or alert information 497.

In some implementations, the server receives, from the second mobile entity, second information of the second mobile entity. The second information may include or correspond to vehicle information 490. The server may select multiple mobile entities to be included in the group based on the first information, the second information, the map information, or a combination thereof.

Additionally, or alternatively, the server may generate the group configuration information that indicates the multiple mobile entities. For example, the group configuration information may be generated based on the map information. To illustrate, the map information may indicate a population density, a traffic density, or a combination thereof. Additionally, or alternatively, the group configuration information may indicate that the first mobile entity is designated as a group leader of the group. The group configuration information also may indicate a transmission scheme of one or more mobile entities of the group with the server. For example, the transmission scheme may indicate a round robin pattern, an alternating pattern between a lead entity and a last entity, or another pattern or scheme for the group to communicate with the server.

In some implementations, the server receives from the first mobile entity, group information. For example, the group information may include or correspond to group information 492. The group information may include a first BSM of the first mobile entity, a portion of a second BSM of the second mobile entity, a CPM, or a combination thereof. Additionally, or alternatively, the server may receive third information from a UE. The UE and the third information may include or correspond to UE 115 and information 406, respectively. In some implementations, the first information may include a first safety message, the second information includes a second safety message, the group information includes a third safety message associated with the group, or a combination thereof. Additionally, or alternatively, the alert information may further be generated based on the third information.

In some implementations, the server estimates, based on the group information, an entry time of the group into a zone. For example, the zone may include or correspond to intersection 478, or intersection information 499. The zone may be associated with the map information. The map information may include or correspond to geographic area 476, map information 488, or a combination thereof. Additionally, or alternatively, the server estimates an exit time of the group from the zone. The exit time estimated based on the first information, the second information, the map information, the group information, the entry time, or a combination thereof.

In some implementations, the server determines a potential collision within the zone. The potential collision may be between at least one mobile entity of the group and an object within the zone. For example, the object may include UE 115 or a mobile device that is not included in the group. The server may generate the alert information based on the determined potential collision. For example, the server may generate alert information 497. The server may transmit the alert information to a group leader of the group, the at least one mobile entity, a mobile entity of the group other than the group leader and the at least one mobile entity, or a combination thereof. For example, the server may transmit alert message 493 that includes or indicates at least a portion of alert information 497.

In some implementations, the server determines, based on the map information, a first subgroup and a second subgroup of the group. In some such implementations, the group configuration information indicates the first subgroup and the second subgroup. Additionally, the first subgroup may include the first mobile entity (e.g., 450), and the second subgroup may include the second mobile entity (e.g., 451). The server may receiving a first group message (e.g., 492) from the first mobile entity included in the first subgroup, and may receive a second group message (e.g., 492) from the second mobile entity.

In some implementations, the server determines, based on the map information, to combine another group of one or more mobile entities and the group to form a combined group. The server may transmit additional group configuration information to the group that indicates the combined group. The additional group configuration information may include or correspond to configuration 491. The server may receive group information (e.g., 492) from at least one mobile entity of the combined group.

In some implementations, the server receives group information from the group. The group information (e.g., 492) may indicate position accuracy information based on DOP information and that is associated with a position estimate of the first mobile entity based on a signal received from a non-terrestrial entity. The accuracy information may include or correspond to accuracy information 495. The signal may be received by the first mobile entity using a non-terrestrial signal sensor, such as non-terrestrial signal sensor 440. The server may generate the alert information based on the position accuracy information.

FIG. 8 is a flow diagram illustrating an example process 800 that supports a safety system according to one or more aspects. Operations of process 800 may be performed by a server, such as core network 130 or server 480, base station 105, or network entity 405, or a server as described with reference to FIG. 12. For example, example operations of process 800 may enable the server to support a safety system.

At block 802, the server receives, from a first mobile entity, an indicator that indicates position accuracy information associated with a position estimate of the first mobile entity based on a signal received from a non-terrestrial entity. For example, the first mobile entity may include or correspond to UE 115, vehicle 450, or vehicle 451. The indicator may include or correspond to vehicle information 490, information 406 or 454, or group information 492. In some implementations, the server may receive a safety message, such as a basic safety message or a pedestrian safety message, that includes the indicator. The safety message may include or correspond to vehicle information 490, information 406 or 454, or group information 492. The position accuracy information may include or correspond to accuracy information 495. In some implementations, the position accuracy information includes a level of accuracy determined based on DOP scalars indicated by a GNSS sensors report. The DOP scalars may include a horizontal DOP, a position DOP, or a combination thereof. Additionally, or alternatively, the DOP scalars may be generated based on a sensor measurement based on the signal received from the non-terrestrial entity. The non-terrestrial entity may include or correspond to a satellite, such as a satellite included in a GNSS.

At block 804, the server transmits alert information to one or more mobile entities. For example, the alert information may include or correspond to alert information 497, alert message 493, or a combination thereof. The alert information may be associated with a potential collision between an object and the one or more mobile entities. The potential collision may be determined based on the indicator. In some implementations, the server may generate the alert information based on based on map information. The map information may include or correspond to geographic area 476, map information 488, intersection information 499, or a combination thereof.

In some implementations, the server may select, based on the indicator, an accuracy value that includes one of a horizontal estimated position error based on historic tracking information, or the position accuracy information. The server may generate a location value (e.g., a position) of the first mobile entity based on the accuracy value. The server may determine the potential collision based on the location value.

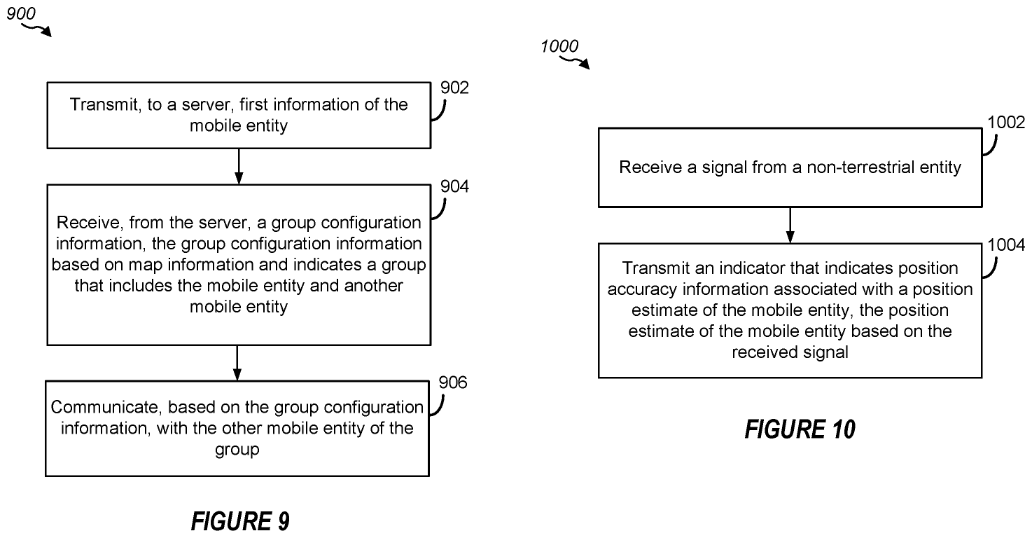

FIG. 9 is a flow diagram illustrating an example process 900 that supports a safety system according to one or more aspects. Operations of process 900 may be performed by a mobile entity, such as UE 115, vehicle 450 or 451, or a network entity as described with reference to FIG. 13. For example, example operations of process 900 may enable the server to support a safety system.

At block 902, the mobile entity transmits, to a server, first information of the mobile entity. For example, the server may include or correspond to server 480. The first information may include or correspond to vehicle information 490, information 454, or a combination thereof.

At block 904, the mobile entity receives, from the server, a group configuration information. For example, the group configuration information may include or correspond to configuration 491, group information 494, or a combination thereof. The group configuration information may be based on map information and may indicate a group that includes the mobile entity and another mobile entity. For example, the group may include vehicle 450 and vehicle 451. Additionally, or alternatively, the group may be associated with first group 487 of group information 494. In some implementations, the group configuration information indicates that the mobile entity is designated as a group leader of the group. Additionally, or alternatively, the group configuration information also may indicate a transmission scheme of one or more mobile entities of the group with the server. For example, the transmission scheme may indicate a round robin pattern, an alternating pattern between a lead entity and a last entity, or another pattern or scheme for the group to communicate with the server. Additionally, or alternatively, the group configuration information may indicate that the group is associated with a combined group of multiple groups. For example, the group may be the combined group that includes multiple sub-groups or may be a sub-group of the combined group.

The map information may include or correspond to geographic area 476, intersection 478, map information 488, intersection information 499, or a combination thereof. The map information may include or indicate a population density, a traffic density, or a combination thereof.

At block 906, the mobile entity communicates, based on the group configuration information, with the other mobile entity of the group. For example, the other mobile entity may include vehicle 451. To communicate with the other mobile entity, the mobile entity and the other mobile entity may perform V2V communication (e.g., 494). In some implementations, the V2V communication may include or be associated with sidelink communication. For example, the mobile entity may establish a sidelink between the mobile entity and the other mobile entity, and may communicate via the sidelink.

In some implementations, the mobile entity transmits group information to the server. For example, the group information may include or correspond to group information 492. The group information may be associated with the group that includes the mobile entity and the other mobile entity.

In some implementations, the mobile entity receives alert information from the server. For example, the alert information may include or correspond to alert information 497, alert message 493, or a combination thereof. The alert information may indicate a potential collision of the mobile entity, a potential collision of another mobile entity of the group, a potential change in travel of the other mobile entity, or a combination thereof.

In some implementations, the mobile entity receives, from the other mobile entity, second information of the other mobile entity. The second information may include or correspond to V2V communication 479. Based on the second information from the other mobile entity, third information of the mobile entity, or a combination thereof, the mobile entity may generate a safety message. For example, the safety message may include or correspond to group information 492. The mobile entity may transmit the safety message to the server.

In some implementations, the mobile entity may transmit group information, such as group information 492, to the server. In some such implementations, the group information may be associated with the group that includes the mobile entity and the other mobile entity. The group information may include a first BSM of the mobile entity, a portion of a second BSM of the other mobile entity, a CPM, or a combination thereof.

In some implementations, the mobile entity may receive a signal from a non-terrestrial entity. For example, the non-terrestrial entity may include or correspond to a satellite, such as a satellite included in a GNSS. The mobile entity may receive the signal using a sensor, such as non-terrestrial signal sensor 449. The mobile entity may determine a position estimate of the mobile entity based on the received signal, and generate an indicator that indicates position accuracy information associated with the position estimate. The accuracy information may include or correspond to accuracy information 495. The mobile entity may transmit the indicator. The indicator may be included in vehicle information 490 or group information 492.

FIG. 10 is a flow diagram illustrating an example process 1000 that supports a safety system according to one or more aspects. Operations of process 1000 may be performed by a mobile entity, such as UE 115, vehicle 450 or 451, or a network entity as described with reference to FIG. 13. For example, example operations of process 1000 may enable the server to support a safety system.

At block 1002, the mobile entity receives a signal from a non-terrestrial entity. For example, the non-terrestrial entity may include or correspond to a satellite, such as a satellite included in a GNSS. The mobile entity may receive the signal using a sensor, such as non-terrestrial signal sensor 449.

In some implementations, the mobile entity determines a position estimate of the mobile entity based on the received signal. Additionally, or alternatively, the mobile entity may generate the indicator that indicates position accuracy information associated with the position estimate. In some implementations, the mobile entity generates, based on the signal, a sensor measurement that includes DOP scalars. The DOP scalars may include a horizontal DOP, a position DOP, or a combination thereof, as illustrative, non-limiting examples. The mobile entity may additionally, or alternatively, generate a GNSS sensors report that indicates DOP scalars. The mobile entity may determine a level of accuracy based on the DOP scalars. In some such implementations, the position accuracy information includes or indicates the determined level of accuracy.

In some implementations, the mobile entity may generate a safety message, such as a basic safety message or a personal safety message, that includes the indicator that indicates a level of accuracy. For example, the safety message may include or correspond to vehicle information 490 or group information 492. Additionally, the mobile entity may transmit the safety message.

At block 1004, the mobile entity transmits an indicator that indicates position accuracy information associated with a position estimate of the mobile entity. The indicator may include or correspond to vehicle information 490, information 406 or 454, or group information 492. The position estimate of the mobile entity may be based on the received signal. The position accuracy information may include or correspond to accuracy information 495.

In some implementations, the mobile entity receives alert information associated with a potential collision between an object and the mobile entity. For example, the alert information may include or correspond to alert information 497, alert message 493, or a combination thereof. The alert information may be received from a server, such as server 480. Additionally, or alternatively, the alert information may be based on the indicator.

FIG. 11 is a perspective view of a motor vehicle with a driver monitoring system according to one or more aspects. A vehicle 1100 may include or communication with a UE within a wireless network 100, as shown in FIG. 1. In some implementations, vehicle 1100 may include or correspond to UE 115i, 115j, or 115k, vehicle 450, or vehicle 451.

Vehicle 1100 may include a front-facing camera 1112 mounted inside the cabin looking through a windshield 1102. Vehicle 1100 may also include a cabin-facing camera 1114 mounted inside the cabin looking towards occupants of vehicle 1100, and in particular the driver of vehicle 1100. Although one set of mounting positions for cameras 1112 and 1114 are shown for vehicle 1100, other mounting locations may be used for camera 1112 or camera 1114. For example, one or more cameras may be mounted on one of the driver or passenger pillars 1126 or one of the driver or passenger pillars 1128, such as near the top of the pillars 1126 or 1128. As another example, one or more cameras may be mounted at the front of vehicle 1100, such as behind the radiator grill 1130 or integrated with bumper 1132. As a further example, one or more cameras may be mounted as part of a driver or passenger side mirror assembly 1134.

Camera 1112 may be oriented such that the field of view of camera 1112 captures a scene in front of vehicle 1100 in the direction that vehicle 1100 is moving when in drive mode or forward direction. In some embodiments, an additional camera may be located at the rear of vehicle 1100 and oriented such that the field of view of the additional camera captures a scene behind vehicle 1100 in the direction that vehicle 1100 is moving when in reverse direction. Although aspects of the disclosure may be described with reference to a “front-facing” camera, referring to camera 1112, the aspects of the disclosure may be applied similarly to a “rear-facing” camera facing in the reverse direction of vehicle 1100. Thus, the benefits obtained while the operator is operating vehicle 1100 in a forward direction may likewise be obtained while the operator is operating vehicle 1100 in a reverse direction.

Further, although embodiments of the disclosure may be described with reference a “front-facing” camera, referring to camera 1112, aspects of the disclosure may be applied similarly to an input received from an array of cameras mounted around vehicle 1100 to provide a larger field of view, which may be as large as 360 degrees around parallel to the ground and/or as large as 360 degrees around a vertical direction perpendicular to the ground. For example, additional cameras may be mounted around the outside of vehicle 1100, such as on or integrated in the doors, on or integrated in the wheels, on or integrated in the bumpers, on or integrated in the hood, and/or on or integrated in the roof.

Camera 1114 may be oriented such that the field of view of camera 1114 is configured to capture a scene in the cabin of vehicle 1100 and includes the user operator of vehicle 1100. In some implementations, camera 1114 is configured to capture the face of the user operator of vehicle 1100 with sufficient detail to discern a gaze direction of the user operator.

Each of cameras 1112 and 1114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

Vehicle 1100 may include, or otherwise be coupled to, an image signal processor for processing image frames from one or more image sensors, such as a first image sensor, a second image sensor, and a depth sensor. Vehicle 1100 may further include or be coupled to a power supply, such as a battery or an alternator. Vehicle 1100 may also include or be coupled to one or more features of FIG. 2, one or more additional features or components that are not shown in FIG. 2, or a combination thereof.

Vehicle 1100 may include a sensor hub for interfacing with sensors to receive data regarding movement of vehicle 1100, data regarding an environment around vehicle 1100, or other non-camera sensor data. The sensor hub may include or be coupled to one or more sensors. One example non-camera sensor is a gyroscope, a device configured for measuring rotation, orientation, or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub may interface to a vehicle bus for sending configuration commands and/or receiving information from vehicle sensors, such as distance (e.g., ranging) sensors or vehicle-to-vehicle (V2V) sensors (e.g., sensors for receiving information from nearby vehicles).

FIG. 12 is a block diagram of an example server 1200 that supports a safety system according to one or more aspects. Server 1200 may be configured to perform operations, including operations described with reference to FIG. 1-4, 7, or 8, or described with reference to the blocks of processes of FIG. 7 or 8. In some implementations, server 1200 includes the structure, hardware, and components shown and described with reference to base station 105, or core network 130. For example, server 1200 may include controller 240, which operates to execute logic or computer instructions stored in memory 242, as well as controlling the components of server 1200 that provide the features and functionality of server 1200. Server 1200, under control of controller 240, transmits and receives signals via wireless radios 1201a-t and antennas 234a-t. Wireless radios 1201a-t include various components and hardware, as illustrated in FIG. 2 for base station 105, including modulator and demodulators 232a-t, transmit processor 220, TX MIMO processor 230, MIMO detector 236, and receive processor 238. Although server 1200 is described as including wireless radios 1201a-t and antennas 234a-t, in other implementations, server 1200 may additionally or alternatively include an interface, such as an interface configured for wired communication.

As shown, the memory 242 may include map information 1202, group information 1203, alert logic 1204, and communication logic 1205. Map information 1202 may include or correspond to map information 488 or intersection information 499. Group information 1203 may include or correspond to configuration 491, group information 492, or group information 494. Alert logic 1204 may be configured to generate alert information 497 based on accuracy information 495, group information 494, threshold 477, map information 1202, or a combination thereof. Alert logic 1204 may also be configured to generate an alert message, such as alert message 493, that is based on alert information 497. Communication logic 1205 may be configured to enable communication between server 1200 and one or more other devices. Server 1200 may receive signals from or transmit signals to one or more UEs (e.g., UE 115), one or more base stations (e.g., base station 105), one or more network entities (e.g., network entity 405), or a network entity 1300 of FIG. 13.

FIG. 13 is a block diagram of an example network entity 1300 that supports a safety system according to one or more aspects. Network entity 1300 may be configured to perform operations described with reference to FIG. 1-4, 9 or 10, or described with reference to the blocks of processes of FIG. 9 or 10. In some implementations, network entity 1300 includes the structure, hardware, and components shown and described with reference to UE 115, base station 105, vehicle 450, vehicle 451, or network entity 405. For example, network entity 1300 includes controller 280, which operates to execute logic or computer instructions stored in memory 282, as well as controlling the components of network entity 1300 that provide the features and functionality of network entity 1300. Network entity 1300, under control of controller 280, transmits and receives signals via wireless radios 1301a-r and antennas 252a-r. Wireless radios 1301a-r include various components and hardware, as illustrated in FIG. 2 for UE 115, including modulator and demodulators 254a-r, MIMO detector 256, receive processor 258, transmit processor 264, and TX MIMO processor 266. As another example, network entity 1300 may include or correspond to a base station, such as base station 105 of FIG. 2. In such implementations, wireless radios 1301a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 282 may include information 1302 and communication logic 1303. Information 1302 may include or correspond to information 406, 434, or 454, vehicle information 490, configuration 491, group information 492, or a combination thereof. Communication logic 1303 may be configured to enable communication between network entity 1300 and one or more other devices. Network entity 1300 may receive signals from or transmit signals to one or more UEs (e.g., UE 115), one or more base stations (e.g., 105), one or more network entities (e.g., network entity 405), one or more mobile entities (e.g., vehicle 450 or 451), core network 130, server 480, or server 1200 of FIG. 12.

It is noted that one or more blocks (or operations) described with reference to FIGS. 7-10 may be combined with one or more blocks (or operations) described with reference to another of the figures. For example, one or more blocks (or operations) of FIG. 7 may be combined with one or more blocks (or operations) of FIG. 8. As another example, one or more blocks (or operations) of FIG. 7 may be combined with one or more blocks (or operations) of FIG. 9 or 10. As another example, one or more blocks (or operations) of FIG. 9 may be combined with one or more blocks (or operations) of FIG. 10. As another example, one or more blocks (or operations) of FIG. 9 may be combined with one or more blocks (or operations) of FIG. 7 or 8. As another example, one or more blocks associated with FIGS. 7-10 may be combined with one or more blocks (or operations) associated with FIGS. 1-6. Additionally, or alternatively, one or more operations described above with reference to FIGS. 1-4 may be combined with one or more operations described with reference to FIG. 5 or 6.

In one or more aspects, techniques for supporting a safety system may include additional aspects, such as any single aspect or any combination of aspects described below or in connection with one or more other processes or devices described elsewhere herein. In a first aspect, supporting a safety system may include an apparatus configured to receive, from a first mobile entity, first information of the first mobile entity. The apparatus is further configured to transmit, to the first mobile entity, a group configuration information. The group configuration information is generated based on the map information and indicates a group that includes the first mobile entity and a second mobile entity. The apparatus is also configured to transmit alert information to the group. Additionally, the apparatus may perform or operate according to one or more aspects as described below. In some implementations, the apparatus includes a device, such as a server, or a component of the device. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the alert information is generated based on the map information.

In a third aspect, in combination with one or more of the first aspect or the second aspect, the map information indicates a population density, a traffic density, or a combination thereof.

In a fourth aspect, in combination with one or more of the first aspect through the third aspect, the group configuration information indicates that the first mobile entity is designated as a group leader of the group.

In a fifth aspect, in combination with one or more of the first aspect through the fourth aspect, the apparatus is further configured to receive, from the second mobile entity, second information of the second mobile entity.

In a sixth aspect, in combination with the fifth aspect, the apparatus is further configured to select multiple mobile entities to be included in the group based on the first information, the second information, the map information, or a combination thereof.

In a seventh aspect, in combination with the sixth aspect, the apparatus is further configured to generate the group configuration information that indicates the multiple mobile entities.

In an eighth aspect, in combination with the seventh aspect, the apparatus is further configured to receive, from the first mobile entity, group information.

In a ninth aspect, in combination with the eighth aspect, the apparatus is further configured to receive, from a UE, third information of the UE.

In a tenth aspect, in combination with the ninth aspect, the first information includes a first safety message, the second information includes a second safety message, the group information includes a third safety message associated with the group, the alert information is further generated based on the third information, or a combination thereof.

In an eleventh aspect, in combination with the seventh aspect, the apparatus is further configured to receive, from the first mobile entity, group information.

In a twelfth aspect, in combination with the eleventh aspect, the group information includes a first BSM of the first mobile entity, a portion of a second BSM of the second mobile entity, a CPM, or a combination thereof.

In a thirteenth aspect, in combination with the twelfth aspect, the apparatus is further configured to estimate, based on the group information, an entry time of the group into a zone, the zone associated with the map information.

In a fourteenth aspect, in combination with the thirteenth aspect, the apparatus is further configured to estimate an exit time of the group from the zone, the exit time estimated based on the first information, the second information, the map information, the group information, the entry time, or a combination thereof.

In a fifteenth aspect, in combination with one or more of the first aspect through the twelfth aspect, the apparatus is further configured to determine a potential collision within a zone. In some implementations, the potential collision is between at least one mobile entity of the group and an object within the zone.

In a sixteenth aspect, in combination with the fifteenth aspect, the apparatus is further configured to generate the alert information based on the determined potential collision.

In a seventeenth aspect, in combination with the sixteenth aspect, the alert information is transmitted to a group leader of the group, the at least one mobile entity, a mobile entity of the group other than the group leader and the at least one mobile entity, or a combination thereof.

In an eighteenth aspect, in combination with one or more of the first aspect through the seventeenth aspect, the group configuration information indicates a transmission scheme of one or more mobile entities of the group with the apparatus.

In a nineteenth aspect, in combination with one or more of the first aspect through the eighteenth aspect, the apparatus is further configured to determine, based on the map information, a first subgroup and a second subgroup of the group.

In a twentieth aspect, in combination with the nineteenth aspect, the group configuration information indicates the first subgroup and the second subgroup, the first subgroup including the first mobile entity, and the second subgroup including the second mobile entity.

In a twenty-first aspect, in combination with the twentieth aspect, the apparatus is further configured to receive a first group message from the first mobile entity included in the first subgroup.

In a twenty-second aspect, in combination with the twenty-first aspect, the apparatus is further configured to receive a second group message from the second mobile entity.

In a twenty-third aspect, in combination with one or more of the first aspect through the twenty-second aspect, the apparatus is further configured to determine, based on the map information, to combine another group of one or more mobile entities and the group to form a combined group.

In a twenty-third aspect, in combination with the twenty-second aspect, the apparatus is further configured to transmit additional group configuration information to the group that indicates the combined group.

In a twenty-fifth aspect, in combination with the twenty-fourth aspect, the apparatus is further configured to receive group information from at least one mobile entity of the combined group.

In a twenty-sixth aspect, in combination with one or more of the first aspect through the twenty-fifth aspect, the apparatus is further configured to receive group information from the group.

In a twenty-seventh aspect, in combination with the twenty-sixth aspect, the group information indicates position accuracy information based on DOP information and associated with a position estimate of the first mobile entity based on a signal received from a non-terrestrial entity.

In a twenty-eighth aspect, in combination with the twenty-seventh aspect, the apparatus is further configured to generate the alert information based on the position accuracy information.

In one or more aspects, techniques for supporting a safety system may include additional aspects, such as any single aspect or any combination of aspects described below or in connection with one or more other processes or devices described elsewhere herein. In a twenty-ninth aspect, supporting a safety system may include an apparatus configured to transmit, to a server, first information of the apparatus. The apparatus is further configured to receive, from the server, a group configuration information. The group configuration information based on map information and indicates a group that includes the apparatus and another mobile entity. The apparatus is also configured to communicate, based on the group configuration information, with the other mobile entity of the group. Additionally, the apparatus may perform or operate according to one or more aspects as described below. In some implementations, the apparatus includes a wireless device, such as a mobile entity, a UE, a vehicle, or a component of the wireless device. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a thirtieth aspect, in combination with the twenty-ninth aspect, the apparatus is further configured to communicate via a sidelink established between the apparatus and the other mobile entity.

In a thirty-first aspect, in combination with the thirtieth aspect, the apparatus is further configured to transmit group information to the server, the group information associated with the group that includes the apparatus and the other mobile entity.

In a thirty-second aspect, in combination with the thirty-first aspect, the map information indicates a population density, a traffic density, or a combination thereof.

In a thirty-third aspect, in combination with the thirty-second aspect or the thirty-second aspect, the group configuration information indicates that the apparatus is designated as a group leader of the group.

In a thirty-fourth aspect, in combination with one or more of the twenty-ninth aspect through the thirty-fourth aspect, the apparatus is further configured to receive alert information from the server.

In a thirty-fifth aspect, in combination with the thirty-third aspect, the alert information indicates a potential collision of the apparatus, a potential collision of another mobile entity of the group, a potential change in travel of the other mobile entity, or a combination thereof.

In a thirty-sixth aspect, in combination with one or more of the twenty-ninth aspect through the thirty-fifth aspect, the apparatus is further configured to receive, from the other mobile entity, second information of the other mobile entity.

In a thirty-seventh aspect, in combination with the thirty-sixth aspect, the apparatus is further configured to generate, based on the second information, third information of the apparatus, or a combination thereof, a safety message.

In a thirty-eighth aspect, in combination with the thirty-seventh aspect, the apparatus is further configured to transmit the safety message to the server.

In a thirty-ninth aspect, in combination with the thirty-eighth aspect, the apparatus is further configured to transmit group information to the server. In some implementations, the group information associated with the group that includes the apparatus and the other mobile entity.

In a fortieth aspect, in combination with the thirty-ninth aspect, the group information includes a first BSM of the apparatus, a portion of a second BSM of the other mobile entity, a CPM; or a combination thereof.

In a forty-first aspect, in combination with one or more of the twenty-ninth aspect through the fortieth aspect, the group configuration information indicates a transmission scheme of one or more mobile entities of the group with the server, the group is included in a combined group of multiple groups, or a combination thereof.

In a forty-second aspect, in combination with one or more of the twenty-ninth aspect through the forty-first aspect, the apparatus is further configured to receive a signal from a non-terrestrial entity.

In a forty-third aspect, in combination with the forty-second aspect, the apparatus is further configured to determine a position estimate of the apparatus based on the received signal.

In a forty-fourth aspect, in combination with the forty-third aspect, the apparatus is further configured to generate an indicator that indicates position accuracy information associated with the position estimate.

In a forty-fifth aspect, in combination with the forty-fourth aspect, the apparatus is further configured to transmit the indicator.

In one or more aspects, techniques for supporting a safety system may include additional aspects, such as any single aspect or any combination of aspects described below or in connection with one or more other processes or devices described elsewhere herein. In a forty-sixth aspect, supporting a safety system may include an apparatus configured to receive a signal from a non-terrestrial entity. The apparatus is further configured to transmit an indicator that indicates position accuracy information associated with a position estimate of the apparatus. The position estimate of the apparatus is based on the received signal. Additionally, the apparatus may perform or operate according to one or more aspects as described below. In some implementations, the apparatus includes a wireless device, such as a mobile entity, a UE, a vehicle, or a component of the wireless device. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a forty-seventh aspect, in combination with the forty-sixth aspect, the apparatus is further configured to receive alert information associated with a potential collision between an object and the apparatus.

In a forty-eighth aspect, in combination with the forty-seventh aspect, the alert information based on the indicator.

In a forty-ninth aspect, in combination with one or more of the forty-sixth aspect through the forty-eighth aspect, the at least one processor is configured to execute the processor-readable code to cause the at least one processor to the apparatus is further configured to generate a GNSS sensors report that indicates DOP scalars.

In a fiftieth aspect, in combination with one or more of the forty-sixth aspect through the forty-eighth aspect, the apparatus is further configured to generate a sensor measurement that includes DOP scalars.

In a fifty-first aspect, in combination with the fiftieth aspect, the DOP scalars include a horizontal DOP, a position DOP, or a combination thereof.

In a fifty-second aspect, in combination with the fifty-first aspect, the apparatus is further configured to determine the position estimate of the apparatus based on the received signal.

In a fifty-third aspect, in combination with the fifty-second aspect, the apparatus is further configured to determine a level of accuracy based on the DOP scalars, wherein the position accuracy information includes the determined level of accuracy.

In a fifty-fourth aspect, in combination with the fifty-third aspect, the apparatus is further configured to generate an indicator.

In a fifty-fifth aspect, in combination with the fifty-fourth aspect, the apparatus is further configured to generate a safety message that includes the indicator that indicates a level of accuracy.

In a fifty-sixth aspect, in combination with the fifty-fifth aspect, the apparatus is further configured to transmit the safety message.

In a fifty-seventh aspect, in combination with the fifty-sixth aspect, the safety message includes a basic safety message or a personal safety message.

In one or more aspects, techniques for supporting a safety system may include additional aspects, such as any single aspect or any combination of aspects described below or in connection with one or more other processes or devices described elsewhere herein. In a fifty-eighth aspect, supporting a safety system may include an apparatus configured to receive, from a first mobile entity, an indicator that indicates position accuracy information associated with a position estimate of the first mobile entity based on a signal received from a non-terrestrial entity. The apparatus is further configured to transmit alert information to one or more mobile entities. The alert information is associated with a potential collision between an object and the one or more mobile entities. The potential collision is determined based on the indicator. Additionally, the apparatus may perform or operate according to one or more aspects as described below. In some implementations, the apparatus includes a device, such as a server, or a component of the device. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a fifty-ninth aspect, in combination with the fifty-eighth aspect, the position accuracy information includes a level of accuracy determined based on DOP scalars indicated by a GNSS sensors report.

In a sixtieth aspect, in combination with the fifty-ninth aspect, the DOP scalars include a horizontal DOP, a position DOP, or a combination thereof.

In a sixty-first aspect, in combination with the sixtieth aspect, the DOP scalars is generated based on a sensor measurement based on the signal received from the non-terrestrial entity.

In a sixty-second aspect, in combination with one or more of the fifty-eighth aspect through the sixty-first aspect, the apparatus is further configured to select, based on the indicator, an accuracy value.

In a sixty-third aspect, in combination with the sixty-second aspect, the accuracy value that includes a horizontal estimated position error based on historic tracking information, or the position accuracy information.

In a sixty-fourth aspect, in combination with sixty-second aspect or the sixty-third aspect, the apparatus is further configured to generate a location value of the first mobile entity based on the accuracy value.

In a sixty-fifth aspect, in combination with the sixty-fourth aspect, the apparatus is further configured to determine the potential collision based on the location value.

In a sixty-sixth aspect, in combination with one or more of the fifty-eighth aspect through the sixty-fifth aspect, the apparatus is further configured to receive a safety message that includes the indicator.

In a sixty-seventh aspect, in combination with the sixty-sixth aspect, the safety message includes a basic safety message or a pedestrian safety message.

In a sixty-eighth aspect, in combination with one or more of the fifty-eighth aspect through the sixty-seventh aspect, the apparatus is further configured to generate the alert information based on based on map information.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-13 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A server comprising:
a memory storing processor-readable code; and
at least one processor coupled to the memory, the at least one processor configured to execute the processor-readable code to cause the at least one processor to:
receive, from a first mobile entity, first information of the first mobile entity;
transmit, to the first mobile entity, a group configuration information, the group configuration information is generated based on the map information and indicates a group that includes the first mobile entity and a second mobile entity; and
transmit alert information to the group.

2. The server of claim 1, wherein:
the alert information is generated based on the map information,
the map information indicates a population density, a traffic density, or a combination thereof;
the group configuration information indicates that the first mobile entity is designated as a group leader of the group; or
a combination thereof.

3. The server of claim 1, wherein the at least one processor is configured to execute the processor-readable code to cause the at least one processor to:
receive, from the second mobile entity, second information of the second mobile entity;
select multiple mobile entities to be included in the group based on the first information, the second information, the map information, or a combination thereof; and
generate the group configuration information that indicates the multiple mobile entities.

4. The server of claim 3, wherein the at least one processor is configured to execute the processor-readable code to cause the at least one processor to:
receive, from the first mobile entity, group information; and
receive, from a user equipment (UE), third information of the UE, and
wherein:
the first information includes a first safety message;
the second information includes a second safety message;
the group information includes a third safety message associated with the group;
the alert information is further generated based on the third information; or
a combination thereof.

5. The server of claim 3, wherein:
the at least one processor is configured to execute the processor-readable code to cause the at least one processor to receive, from the first mobile entity, group information; and
the group information includes:
a first basic safety message (BSM) of the first mobile entity;
a portion of a second BSM of the second mobile entity;
a collective perception message (CPM); or
a combination thereof.

6. The server of claim 5, wherein the at least one processor is configured to execute the processor-readable code to cause the at least one processor to:
estimate, based on the group information, an entry time of the group into a zone, the zone associated with the map information; and
estimate an exit time of the group from the zone, the exit time estimated based on the first information, the second information, the map information, the group information, the entry time, or a combination thereof.

7. The server of claim 1, wherein:
the at least one processor is configured to execute the processor-readable code to cause the at least one processor to:
determine a potential collision within a zone, the potential collision between at least one mobile entity of the group and an object within the zone; and
generate the alert information based on the determined potential collision, and
the alert information is transmitted to:
a group leader of the group;
the at least one mobile entity;
a mobile entity of the group other than the group leader and the at least one mobile entity; or
a combination thereof.

8. The server of claim 1, wherein the group configuration information indicates a transmission scheme of one or more mobile entities of the group with the server.

9. The server of claim 1, wherein the at least one processor is configured to execute the processor-readable code to cause the at least one processor to:
determine, based on the map information, a first subgroup and a second subgroup of the group, wherein the group configuration information indicates the first subgroup and the second subgroup, the first subgroup including the first mobile entity, and the second subgroup including the second mobile entity;
receive a first group message from the first mobile entity included in the first subgroup; and
receive a second group message from the second mobile entity.

10. The server of claim 1, wherein the at least one processor is configured to execute the processor-readable code to cause the at least one processor to:
determine, based on the map information, to combine another group of one or more mobile entities and the group to form a combined group;
transmit additional group configuration information to the group that indicates the combined group; and
receive group information from at least one mobile entity of the combined group.

11. The server of claim 1, wherein the at least one processor is configured to execute the processor-readable code to cause the at least one processor to:
receive group information from the group, the group information indicates position accuracy information based on dilution of precision (DOP) information and associated with a position estimate of the first mobile entity based on a signal received from a non-terrestrial entity; and
generate the alert information based on the position accuracy information.

12. A mobile entity comprising:
a memory storing processor-readable code; and
at least one processor coupled to the memory, the at least one processor configured to execute the processor-readable code to cause the at least one processor to:
transmit, to a server, first information of the mobile entity;
receive, from the server, a group configuration information, the group configuration information based on map information and indicates a group that includes the mobile entity and another mobile entity; and
communicate, based on the group configuration information, with the other mobile entity of the group.

13. The mobile entity of claim 12, wherein the at least one processor is configured to execute the processor-readable code to cause the at least one processor to:
communicate via a sidelink established between the mobile entity and the other mobile entity; and
transmit group information to the server, the group information associated with the group that includes the mobile entity and the other mobile entity, and
wherein:
the map information indicates a population density, a traffic density, or a combination thereof;
the group configuration information indicates that the mobile entity is designated as a group leader of the group; or
a combination thereof.

14. The mobile entity of claim 12, wherein:
the at least one processor is configured to execute the processor-readable code to cause the at least one processor to receive alert information from the server; and
the alert information indicates:
a potential collision of the mobile entity;
a potential collision of another mobile entity of the group;
a potential change in travel of the other mobile entity; or
a combination thereof.

15. The mobile entity of claim 12, wherein the at least one processor is configured to execute the processor-readable code to cause the at least one processor to:
receive, from the other mobile entity, second information of the other mobile entity;
generate, based on the second information, third information of the mobile entity, or a combination thereof, a safety message; and
transmit the safety message to the server.

16. The mobile entity of claim 15, wherein:
the at least one processor is configured to execute the processor-readable code to cause the at least one processor to transmit group information to the server, the group information associated with the group that includes the mobile entity and the other mobile entity; and
the group information includes:
a first basic safety message (BSM) of the mobile entity;
a portion of a second BSM of the other mobile entity;
a collective perception message (CPM); or
a combination thereof.

17. The mobile entity of claim 12, wherein the group configuration information indicates:
a transmission scheme of one or more mobile entities of the group with the server;
the group is included in a combined group of multiple groups; or
a combination thereof.

18. The mobile entity of claim 12, wherein the at least one processor is configured to execute the processor-readable code to cause the at least one processor to:
receive a signal from a non-terrestrial entity;
determine a position estimate of the mobile entity based on the received signal;
generate an indicator that indicates position accuracy information associated with the position estimate; and
transmit the indicator.

19. A mobile entity comprising:
a memory storing processor-readable code; and
at least one processor coupled to the memory, the at least one processor configured to execute the processor-readable code to cause the at least one processor to:
receive a signal from a non-terrestrial entity; and
transmit an indicator that indicates position accuracy information associated with a position estimate of the mobile entity, the position estimate of the mobile entity based on the received signal.

20. The mobile entity of claim 19, wherein the at least one processor is configured to execute the processor-readable code to cause the at least one processor to:
receive alert information associated with a potential collision between an object and the mobile entity, and
wherein the alert information based on the indicator.

21. The mobile entity of claim 19, wherein the at least one processor is configured to execute the processor-readable code to cause the at least one processor to generate a global navigation satellite system (GNSS) sensors report that indicates dilution of precision (DOP) scalars.

22. The mobile entity of claim 19, wherein the at least one processor is configured to execute the processor-readable code to cause the at least one processor to: generate a sensor measurement that includes dilution of precision (DOP) scalars, the DOP scalars include a horizontal DOP, a position DOP, or a combination thereof.

23. The mobile entity of claim 22, wherein the at least one processor is configured to execute the processor-readable code to cause the at least one processor to:
determine the position estimate of the mobile entity based on the received signal;
determine a level of accuracy based on the DOP scalars, wherein the position accuracy information includes the determined level of accuracy;
generate an indicator;
generate a safety message that includes the indicator that indicates a level of accuracy; and
transmit the safety message.

24. The mobile entity of claim 23, wherein the safety message includes a basic safety message or a personal safety message.

25. A server comprising:
a memory storing processor-readable code; and
at least one processor coupled to the memory, the at least one processor configured to execute the processor-readable code to cause the at least one processor to:
receive, from a first mobile entity, an indicator that indicates position accuracy information associated with a position estimate of the first mobile entity based on a signal received from a non-terrestrial entity; and
transmit alert information to one or more mobile entities, the alert information associated with a potential collision between an object and the one or more mobile entities, the potential collision determined based on the indicator.

26. The server of claim 25, wherein the position accuracy information includes a level of accuracy determined based on dilution of precision (DOP) scalars indicated by a global navigation satellite system (GNSS) sensors report.

27. The server of claim 26, wherein:
the DOP scalars include a horizontal DOP, a position DOP, or a combination thereof;
the DOP scalars is generated based on a sensor measurement based on the signal received from the non-terrestrial entity; or
a combination thereof.

28. The server of claim 25, wherein the at least one processor is configured to execute the processor-readable code to cause the at least one processor to:
select, based on the indicator, an accuracy value that includes:
a horizontal estimated position error based on historic tracking information; or
the position accuracy information;
generate a location value of the first mobile entity based on the accuracy value; and
determine the potential collision based on the location value.

29. The server of claim 25, wherein:
the at least one processor is configured to execute the processor-readable code to cause the at least one processor to receive a safety message that includes the indicator; and
the safety message includes a basic safety message or a pedestrian safety message.

30. The server of claim 25, wherein the at least one processor is configured to execute the processor-readable code to cause the at least one processor to generate the alert information based on based on map information.
